(19) United States
(12) Patent Application Publication
(10) Pub. No.: US 2023/0241553 A1
(43) Pub. Date: Aug. 3, 2023

(54) SYSTEM AND METHOD FOR CIRCULATING AIR

(71) Applicant: THE ROYAL INSTITUTION FOR THE ADVANCEMENT OF LEARNING / MCGILL UNIVERSITY, Montréal (CA)

(72) Inventors: Mark LEFSRUD, Hudson (CA); Sazan RAHMAN, Montréal (CA); Tristan CHAUVIN-BOSSE, Montréal (CA)

(21) Appl. No.: 18/162,973

(22) Filed: Feb. 1, 2023

Related U.S. Application Data
(60) Provisional application No. 63/305,721, filed on Feb. 2, 2022.

(51) Int. Cl. B01D 53/85; F24F 8/175; B01D 53/44; B01D 53/34

(52) U.S. Cl. CPC B01D 53/85; F24F 8/175; B01D 53/44; B01D 53/346; B01D 2258/06

(57) ABSTRACT

There is provided a system for circulating air. The system for circulating air has a concrete element that has an open cell porous matrix concrete. The concrete element has an inner surface opposite an outer surface. The inner surface faces an enclosed dwelling space of a building. The system for circulating air has an air circulation conduit in fluid flow communication with the outer surface of the concrete element, and a fan configured to circulate air along the air circulation conduit and through the open cell porous matrix, across a thickness of the concrete element, into the enclosed dwelling space.

### CROSS-REFERENCE TO A RELATED APPLICATION

The present application claims priority from U.S. provisional patent application 63/305,721 filed on Feb. 2, 2022 and herewith incorporated by reference in its entirety.

### TECHNICAL FIELD

This disclosure generally relates to the field of ventilation, and of temperature and/or humidity control of enclosed spaces.

### BACKGROUND OF THE ART

One important function of systems associated to enclosed spaces is the control of the air conditions in the enclosed space. More specifically, depending on the surrounding environmental conditions and of the specific context, an enclosed space may require temperature control, humidity control, and/or ventilation, which may require filtration and occasional air exchanges with the environment. Various technologies have been developed to this end over the years, such as heating, ventilation and air conditioning (HVAC) systems which are widely used in residential, commercial and industrial buildings, which typically involve an air recirculation circuit or network, to and from the enclosed space. Such an air recirculation circuit typically involves air outlets through which air from the circuit is released to the enclosed space, air inlets through which air from the enclosed space is aspired into the circuit, ducting delimiting the circuit, and one or more fans to drive the air circulation from the inlets to the outlets, but such systems can further include an air heater, an air cooler/conditioner, and/or an air filter within the recirculation circuit. While such systems have been satisfactory to a certain degree, there always remains room for improvement.

### SUMMARY

While several technologies have been used for controlling indoor air characteristics such as air quality, temperature and humidity, there have been very little in terms of major changes over the last decades, and typical elements are typically used at various power ratings, in typical ways to achieve the desired objectives, within known, perhaps assumed limitations.

It was found that, introducing a concrete element having an open-cell porous matrix concrete in a manner to intersect the air recirculation circuit, and therefore be used as a component of the air recirculation circuit, could lead to surprising advantages in some embodiments. For instance, the porous concrete element could serve to achieve a coarse filtration of the air, or simply achieving a highly even, low speed, air inlet or air outlet leading to increased comfort of the dwellers. In more evolved version, it was found that suitable temperature control could be achieved using such a porous concrete element, by using the porous concrete element as a heat exchange medium. Indeed, by heating or cooling the porous concrete element, and circulating air through/across the porous concrete element, it was found that temperature control of the air in the enclosed space could be achieved. Similarly, by humidifying or dehumidifying the porous concrete element, humidity control of the air in the enclosed space could be achieved. Finally, such a porous concrete element could be used, in some embodiments, as a growing substrate for plants, and thus form a green wall, in which case additional advantages associated to the presence of the plants, such as oxygen generation, volatile organic compound removal, filtration, and/or humidity control could be achieved.

In one aspect, there is provided a system for circulating air, the system comprising: a concrete element being an open cell porous matrix concrete and having inner surface opposite an outer surface, the inner surface facing an enclosed space of a building, and a thickness between the outer surface and the inner surface; an air circulation conduit in fluid flow communication with the outer surface of the concrete element; and a fan configured to circulate air along the air circulation conduit and through the open cell porous matrix, across a thickness of the concrete element, into the enclosed space. In some embodiments, the concrete element is a wall. In some embodiments, the concrete element has a porosity of from 15 to 40%, preferably between 25% and 35%. In some embodiments, the concrete element has a thickness of from 10 to 100 cm, preferably between 15 and 40 cm. In some embodiments, the concrete element has a permeability of from 2 to 6 mm s⁻¹. In some embodiments, a pressure differential ΔP across the thickness of the concrete element is in the range of 0.1 to 100 kPa, preferably 0.2 to 20 kPa. In some embodiments, the air circulation conduit includes an air inlet configured to draw air from the enclosed space. In some embodiments, the system for circulating further comprises a filter positioned between the fan and the air inlet. In some embodiments, the air circulation conduit includes an external air inlet configured to draw air from an external source and a valve configured to selectively open and close the external air inlet.

In some embodiments, the system for circulating air further comprises a temperature control element configured to exchange heat with the concrete element. In some embodiments, the temperature control element is a fluid circulation pipe or an electric heating element. 1 In some embodiments, the temperature control element is embedded within the open cell porous matrix of the concrete element. In some embodiments, the system for circulating air further comprises a first thermometer to measure a temperature of the concrete element; a second thermometer to measure a temperature of air in the enclosed space, and a controller coupled to the first thermometer, the second thermometer, and the temperature control element. In some embodiments, the controller is a thermostat. In some embodiments, the controller is configured to receive an input from the second thermostat and an input from the first thermometer, and to output instructions to the temperature control element in order to regulate the temperature of air in the enclosed space to be within a predetermined range of temperatures based on a temperature calibration curve.

In some embodiments, the system for circulating air further comprises a humidity control element in fluid communication with the concrete element. In some embodiments, the humidity control element is embedded in the open cell porous matrix concrete. In some embodiments, the humidity control element is a perforated circulation pipe configured to circulate an aqueous phase through the concrete element. In some embodiments, the system for circulating air further comprises a first hygrometer to measure a relative humidity of the concrete element, a second hygrometer to measure a humidity of the air in the enclosed space, and a controller coupled to the first hygrometer, the second hygrometer, and the humidity control element. In some embodiments, the controller is configured to receive an input from the first hygrometer and an input from the second hygrometer, and to output instructions to the humidity control element in order to regulate the humidity of the air in the enclosed space to be within a predetermined range based on a humidity calibration curve.

In some embodiments, the system for circulating air further comprises a vegetation layer on the inner surface of the concrete element. In some embodiments, the system for circulating air further comprises a hydroponic unit adapted to store a hydroponic solution, in fluid communication with the vegetation layer, to provide the hydroponic solution to the vegetation layer. In some embodiments, the hydroponic unit is in fluid communication with the humidity control element. In some embodiments, the aqueous phase is a hydroponic solution. In some embodiments, the concrete element has a pH of less than 10.

In one aspect, there is provided a method of circulating air through a thickness of a concrete element into an enclosed space, the method comprising: drawing air from the enclosed space into an air circulation conduit, the air circulation conduit being in fluid flow communication with the outer surface of the concrete element; and blowing air from the air circulation conduit through the thickness of the concrete element from the outer surface into the enclosed space.

In some embodiments, the method further comprises: measuring a temperature of the enclosed space; measuring a temperature of the concrete element; determining whether the temperature of the enclosed space is above or below a predetermined temperature range; and modifying the temperature of the concrete element to bring the temperature of the enclosed space to within the predetermined range. In some embodiments, modifying the temperature of the concrete element comprises one of: (i) increasing heating, (ii) decreasing heating, (iii) increasing cooling, and (iv) decreasing cooling, of a temperature control element. In some embodiments, the temperature of the concrete element is modified according to a temperature calibration curve that correlates the temperature of the concrete element with the temperature of the enclosed space.

In some embodiments, the method further comprises: measuring a humidity of the enclosed space; measuring a relative humidity of the concrete element; determining whether the humidity of the enclosed space is above or below a predetermined humidity range; and modifying the relative humidity of the concrete element to bring the humidity of the enclosed space to within the predetermined humidity range. In some embodiments, the relative humidity of the concrete element is modified according to a humidity calibration curve that correlates the humidity of the enclosed space with the relative humidity of the concrete element.

In some embodiments, the method further comprises filtering air with a vegetation layer on an inner surface of the concrete element opposite the outer surface. In some embodiments, the vegetation layer absorbs volatile organic compounds (VOC). In some embodiments, the vegetation layer provides oxygen to the enclosed space. In some embodiments, the vegetation layer absorbs or release moisture to control the humidity of the enclosed space.

Many further features and combinations thereof concerning the present improvements will appear to those skilled in the art following a reading of the instant disclosure.

### DESCRIPTION OF THE DRAWINGS

FIG. 1A is a schematic cross section view of a system for circulating air according to an embodiment.

FIG. 1B is a schematic cross section view of the system of FIG. 1A with temperature control.

FIG. 10 is a schematic cross section view of the system of FIG. 1A with humidity control.

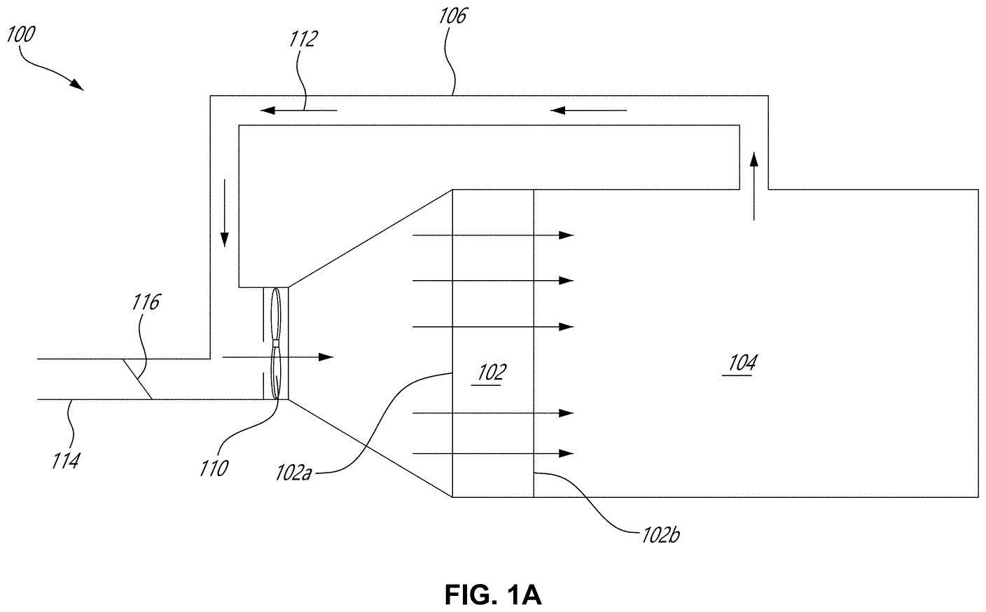

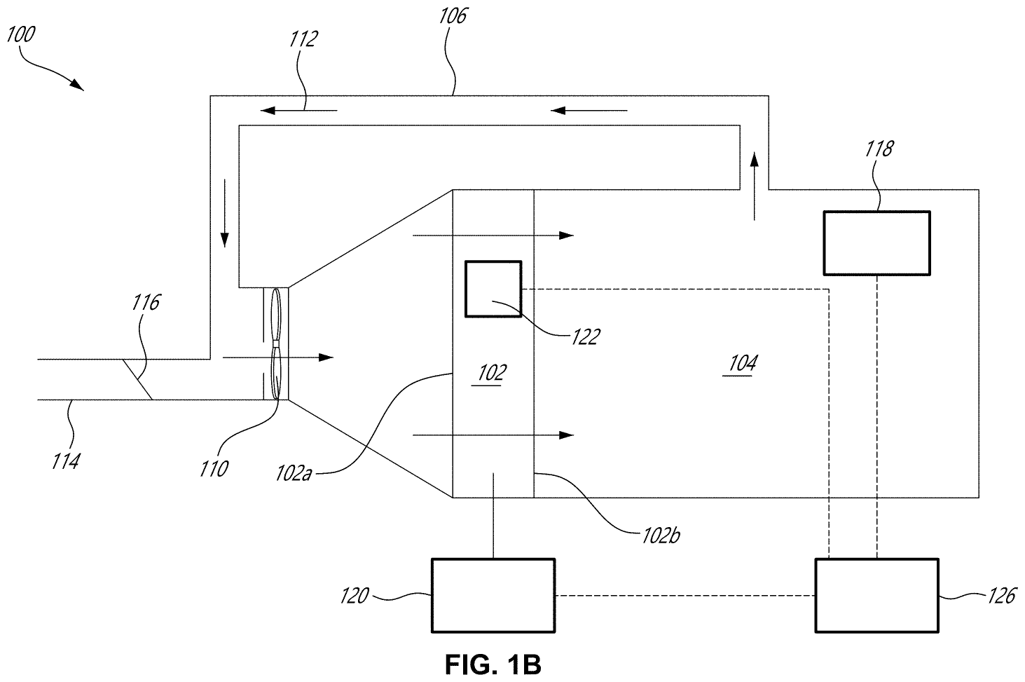

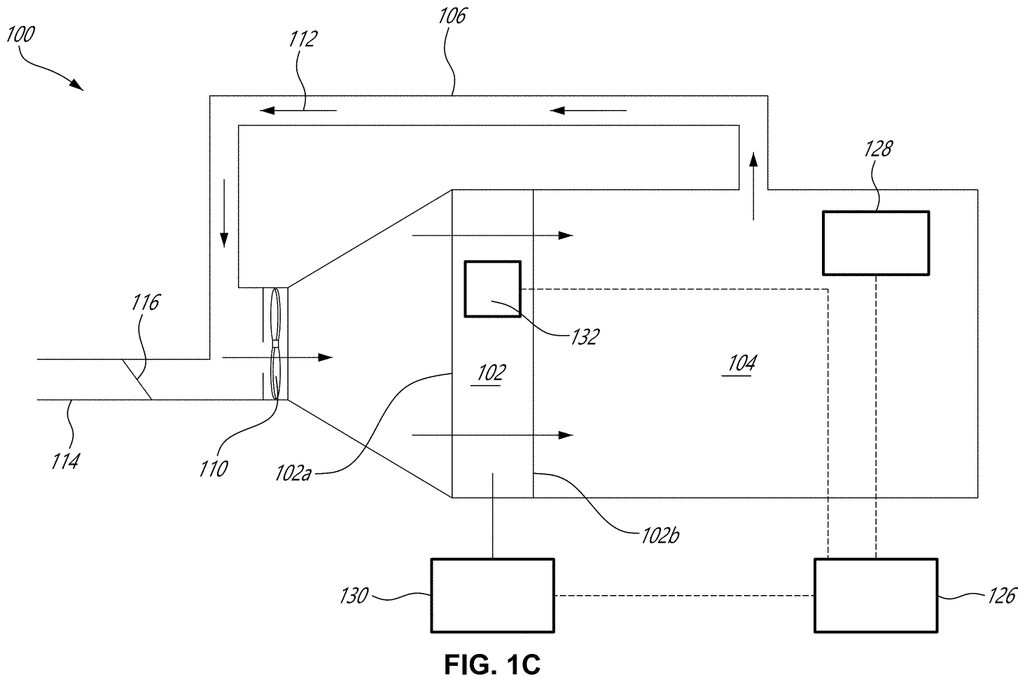

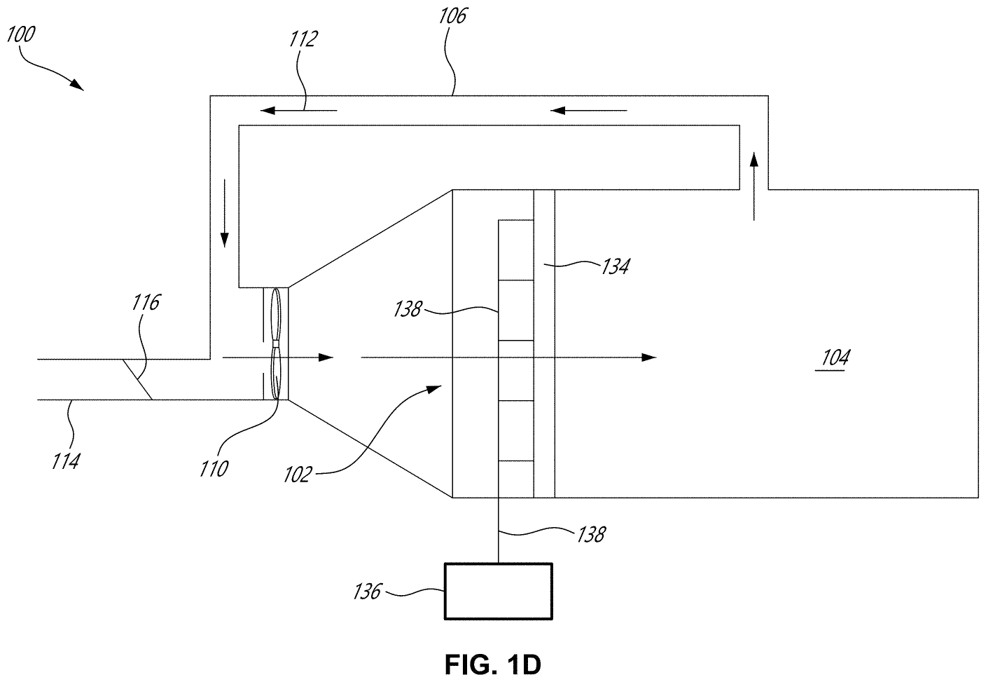

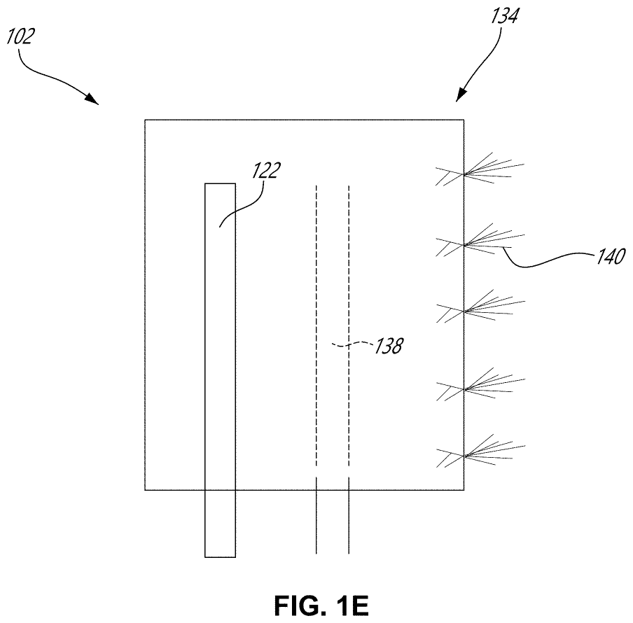

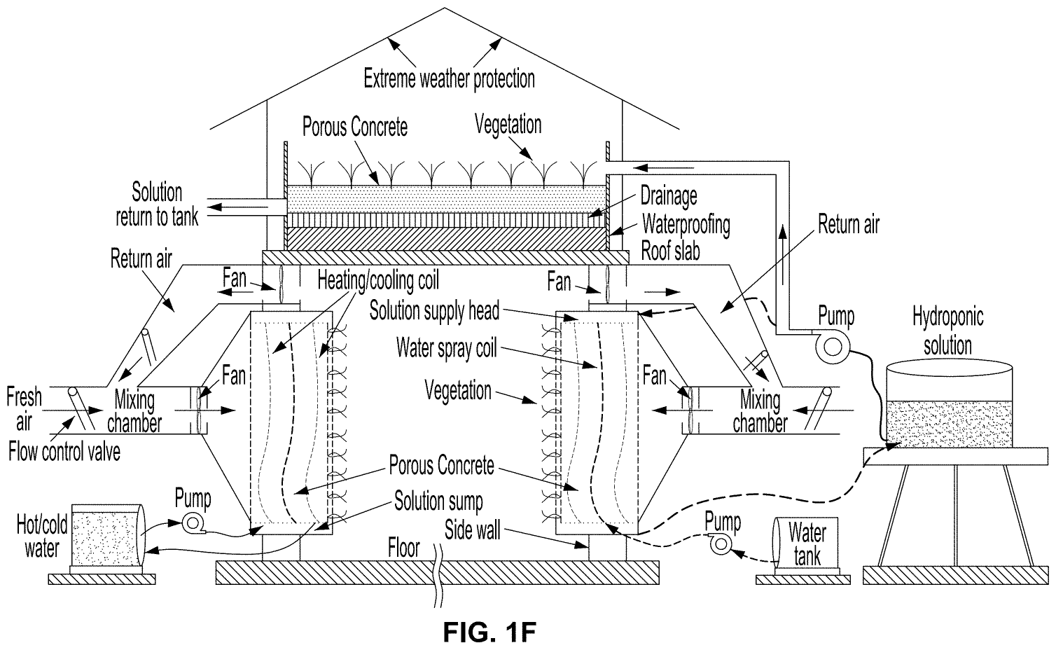

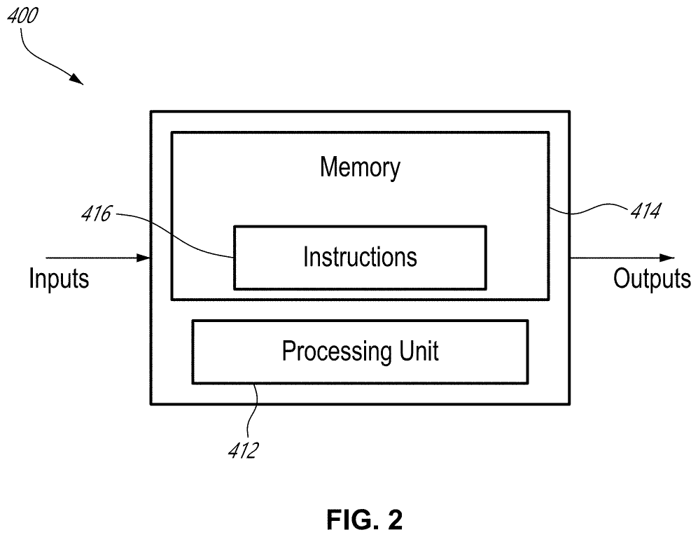

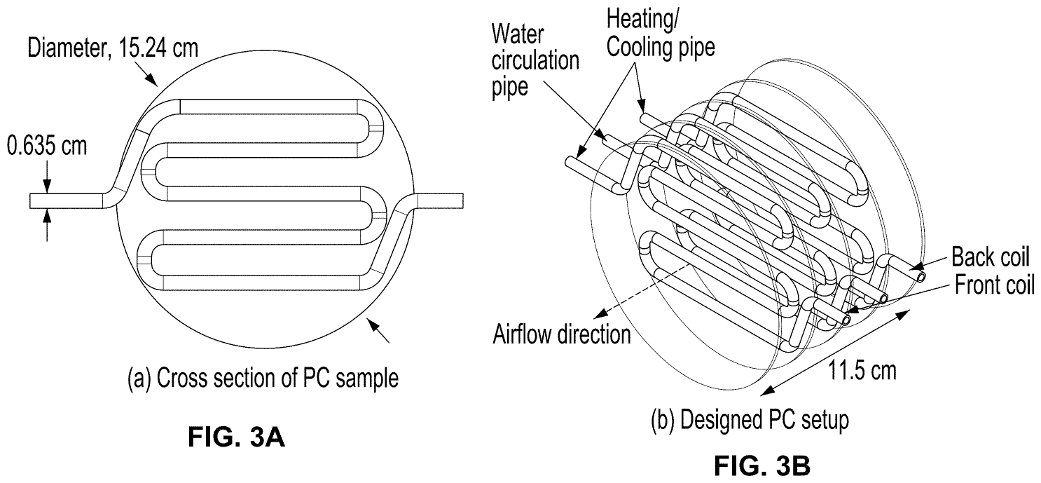

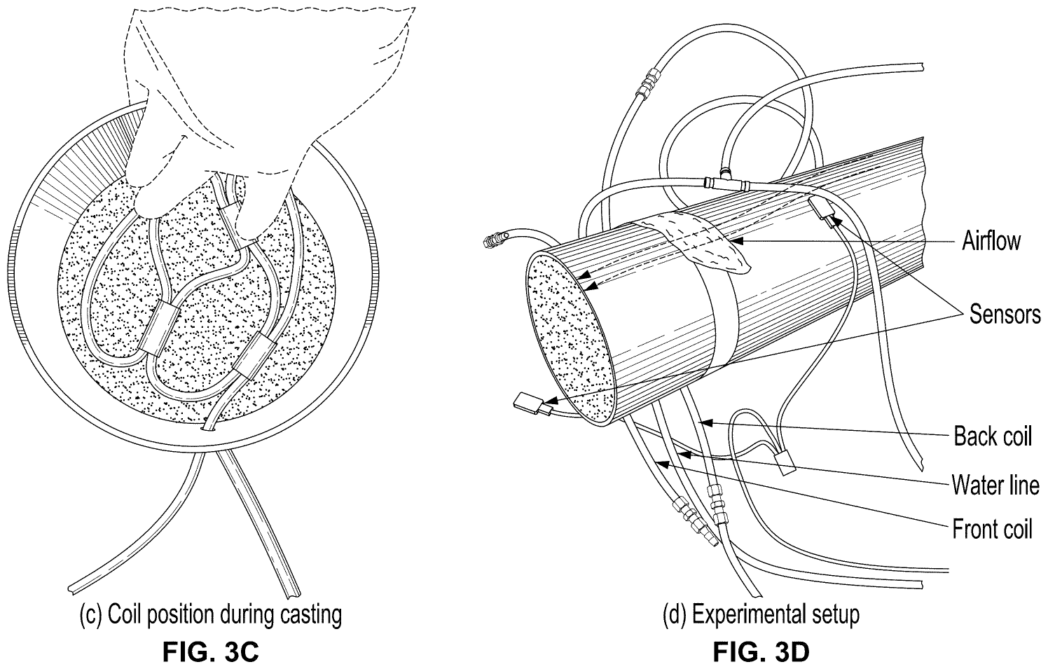

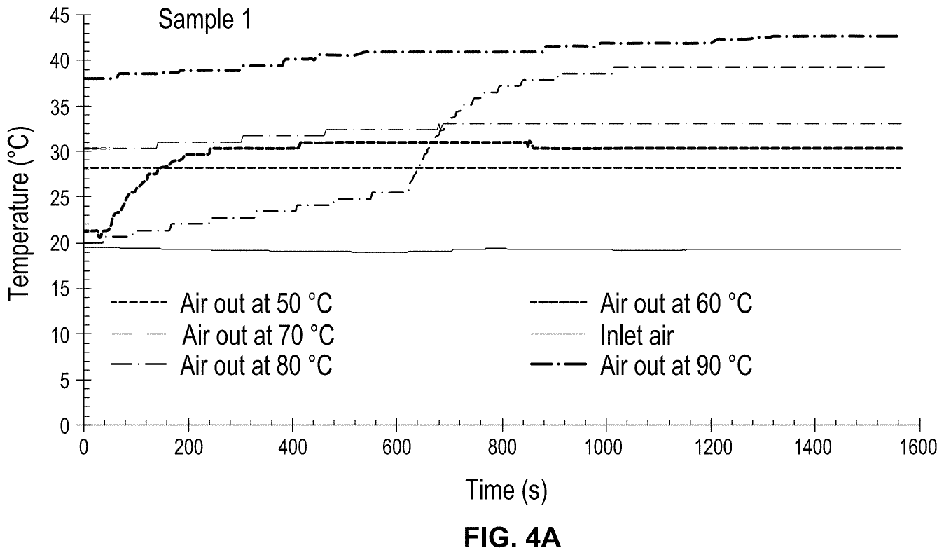

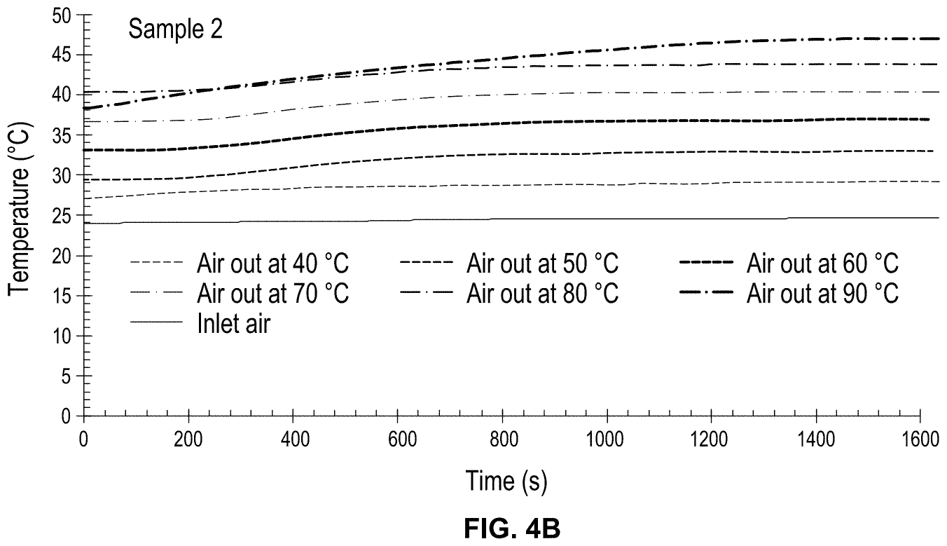

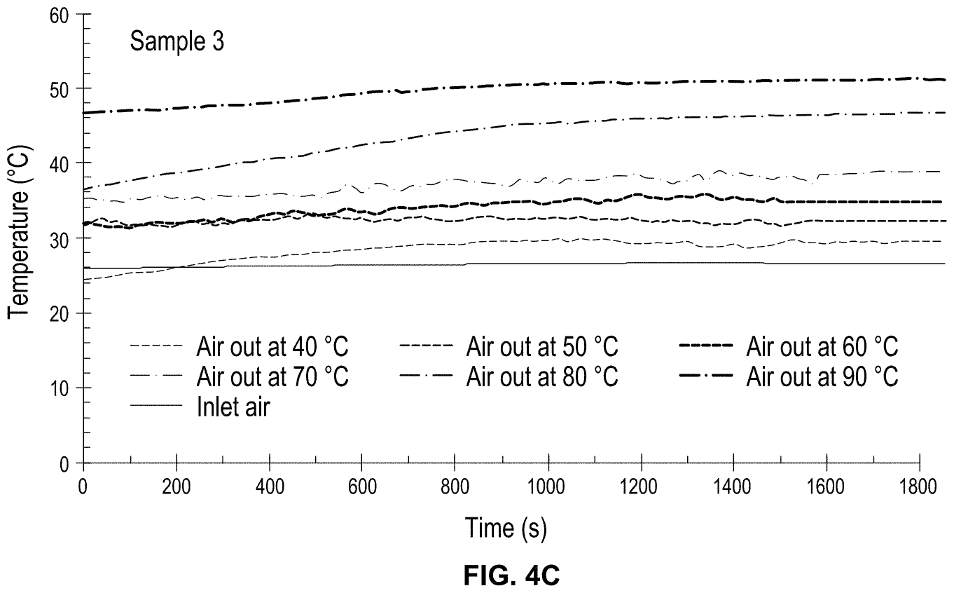

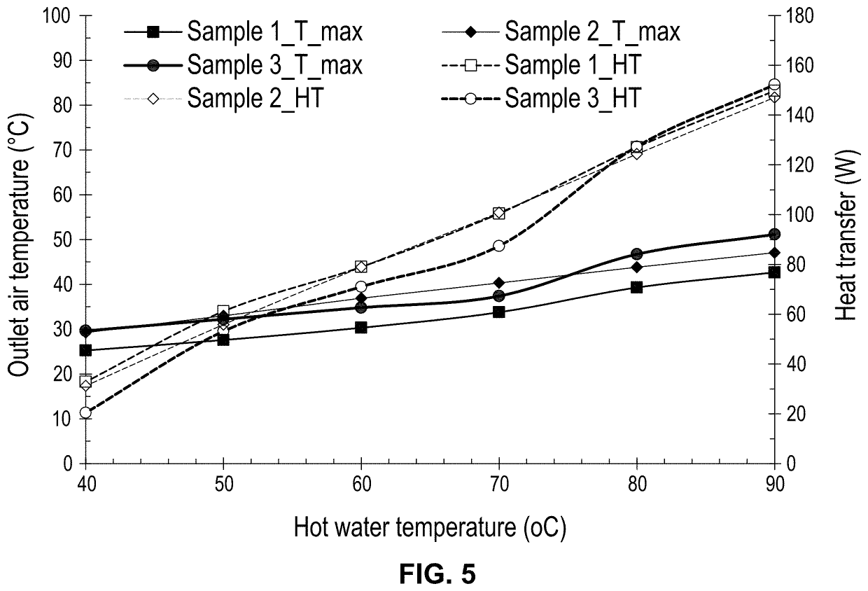

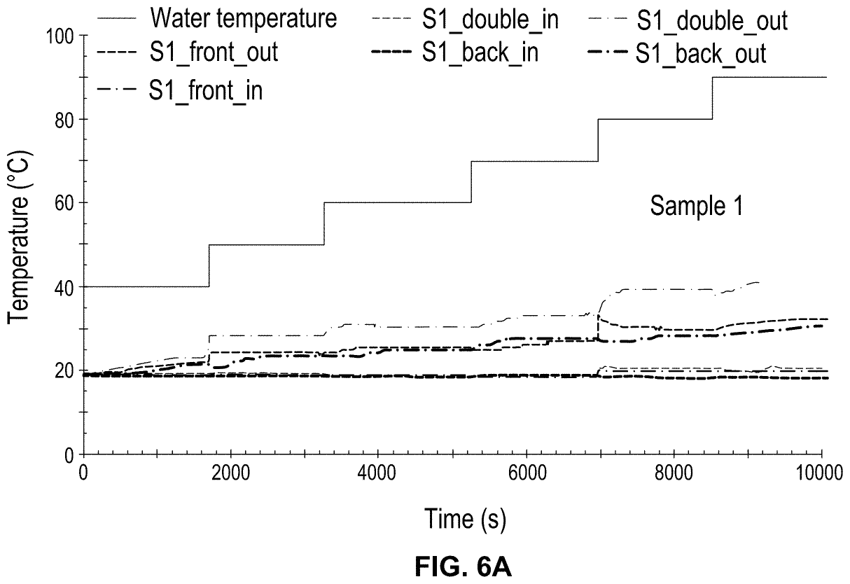

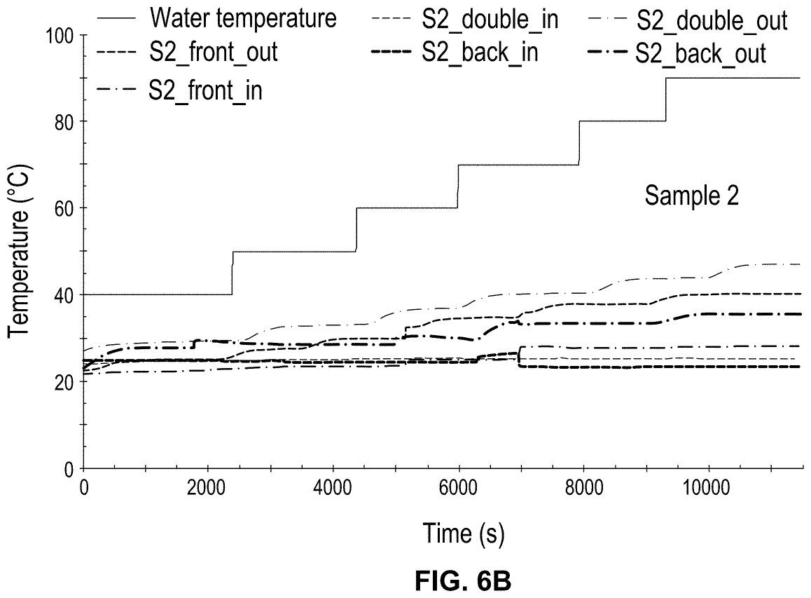

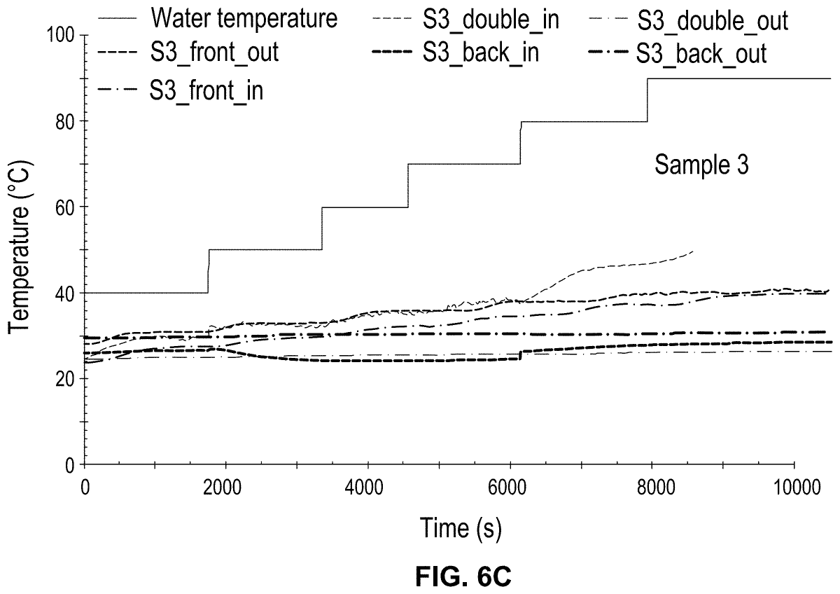

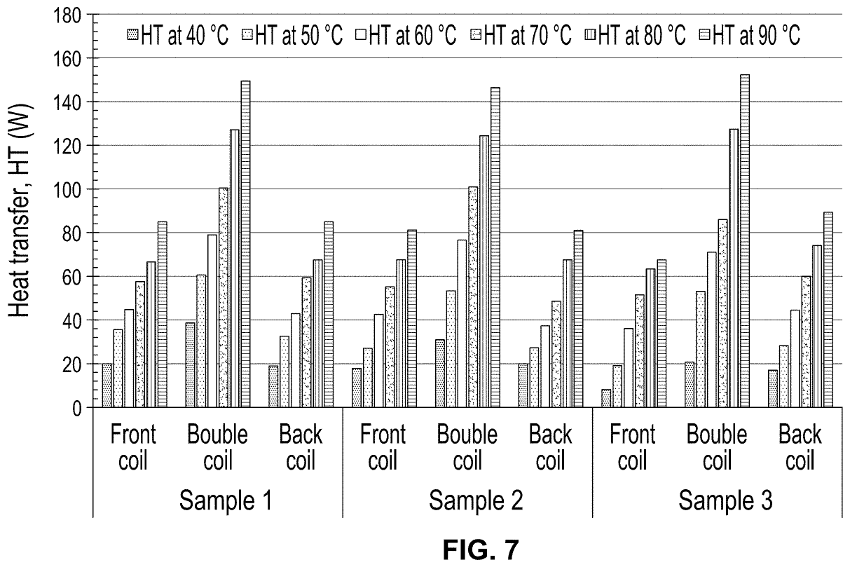

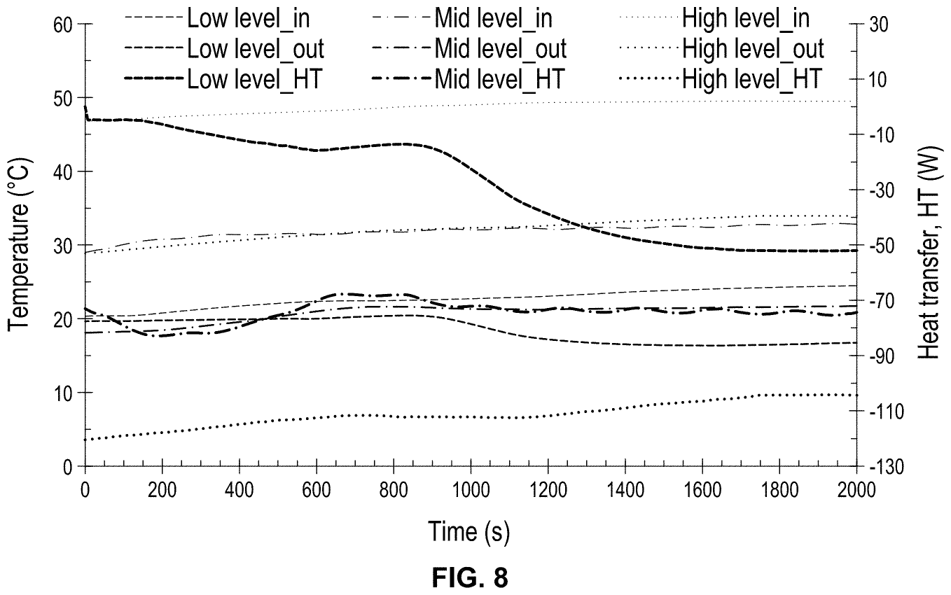

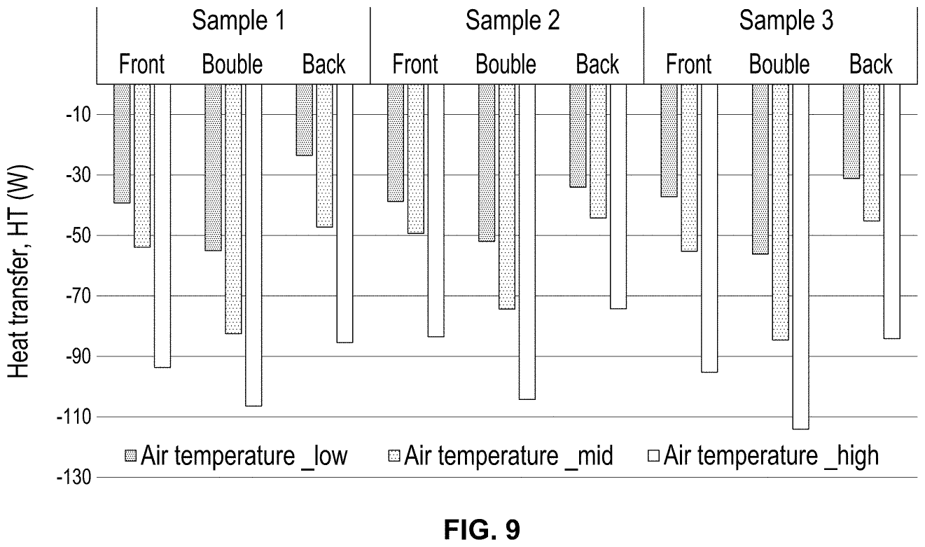

FIG. 1D is a schematic cross section view of the system of FIG. 1A with a vegetation layer.

FIG. 1E is a schematic cross section view of a concrete element according to an embodiment.

FIG. 1F is a schematic cross section view of a system for circulating air with minimal fresh air intake and air recycling according to an embodiment.

FIG. 2 is a block diagram of a controller according to an embodiment.

FIG. 3A is a schematic cross section of a porous concrete (PC) sample used in Example 1.

FIG. 3B is a schematic exploded view of a PC set up used in Example 1.

FIG. 3C is a schematic top view of the PC sample used in Example 1.

FIG. 3D is a schematic front elevation view of the PC set up used in Example 1.

FIG. 4A is a graph showing the temperature profile in function of time for sample 1 of Example 1 when heated with hot water increasing at 10 t-increments and flowing through embedded PVC piping.

FIG. 4B is a graph showing the temperature profile in function of time for sample 2 of Example 1 when heated with hot water increasing at 10 t-increments and flowing through embedded PVC piping.

FIG. 4C is a graph showing the temperature profile in function of time for sample 3 of Example 1 when heated with hot water increasing at 10 t-increments and flowing through embedded PVC piping.

FIG. 5 is a graph showing the maximum air temperature and heat transfer with different fluid temperatures for the three samples of FIGS. 4A-4C.

FIG. 6A is a graph showing the temperature changing rates in function of time for sample 1 of Example 1 with different coil arrangements.

FIG. 6B is a graph showing the temperature changing rates in function of time for sample 2 of Example 1 with different coil arrangements.

FIG. 6C is a graph showing the temperature changing rates in function of time for sample 3 of Example 1 with different coil arrangements.

FIG. 7 is a bar graph showing heat transfer (HT) rate for all three PC samples of Example 1 with different coil arrangements at different water temperatures.

FIG. 8 is a graph showing the temperature change and heat transfer (HT) rate of PC when double coil cooling at different input air temperatures for sample 2 of Example 1.

FIG. 9 is a bar graph showing the heat loss from PC to air during cooling with samples 1, 2, and 3 of Example 1 having different coil arrangements each (front, double, and back).

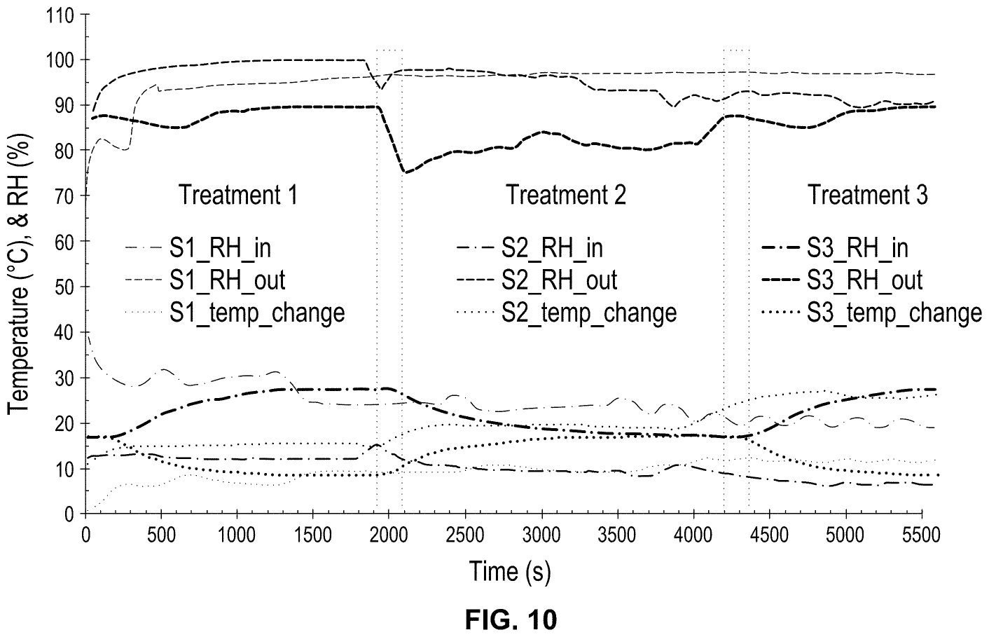

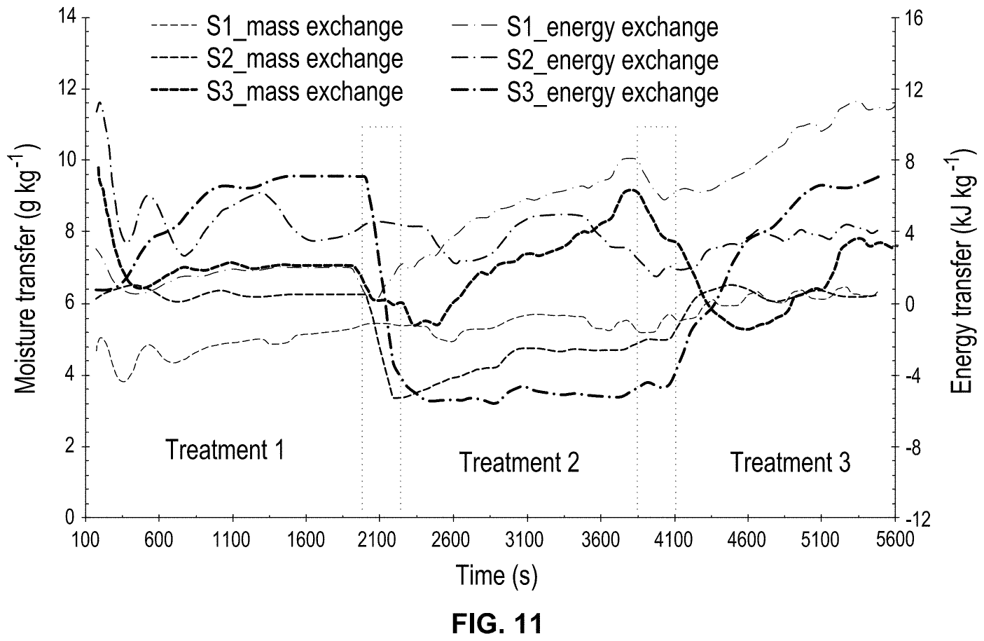

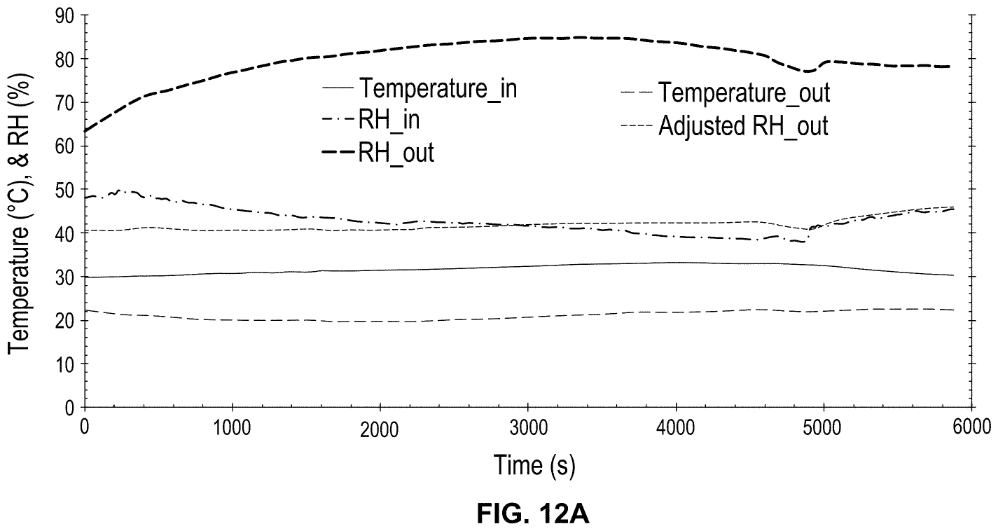

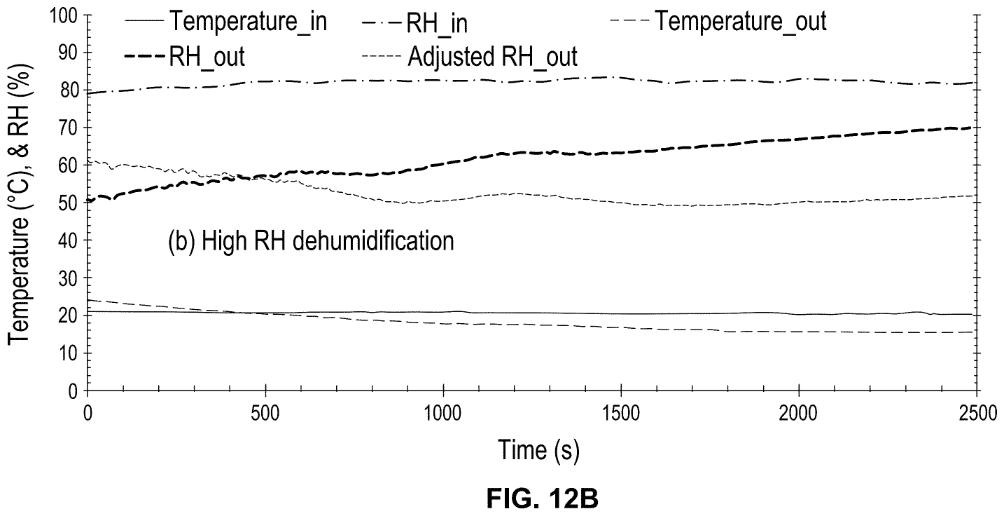

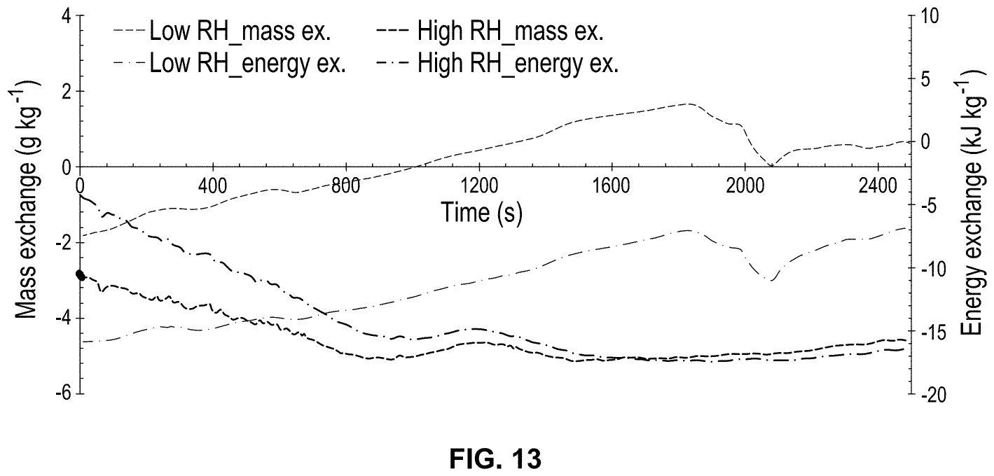

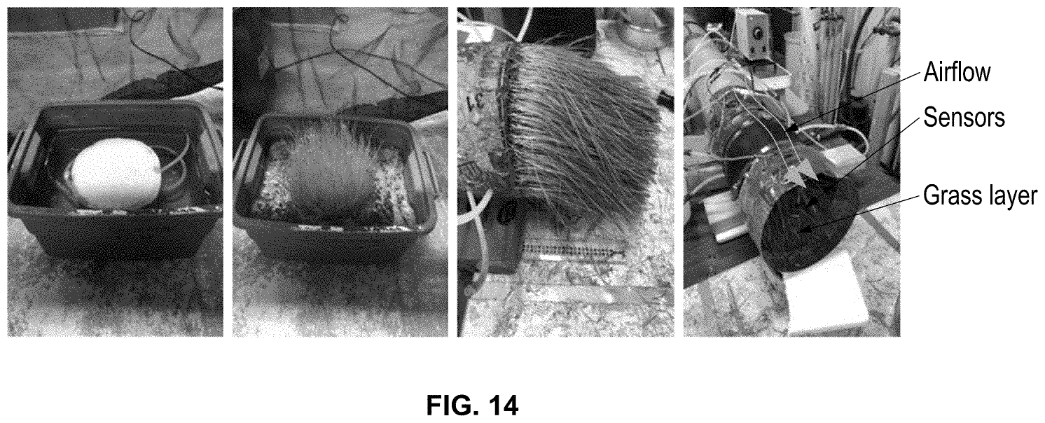

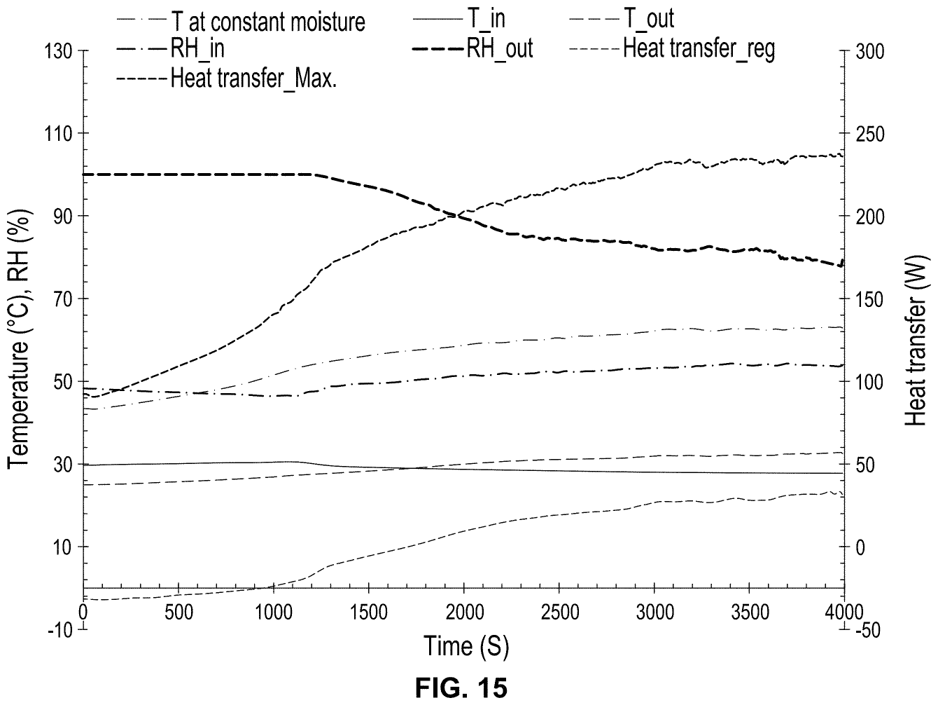

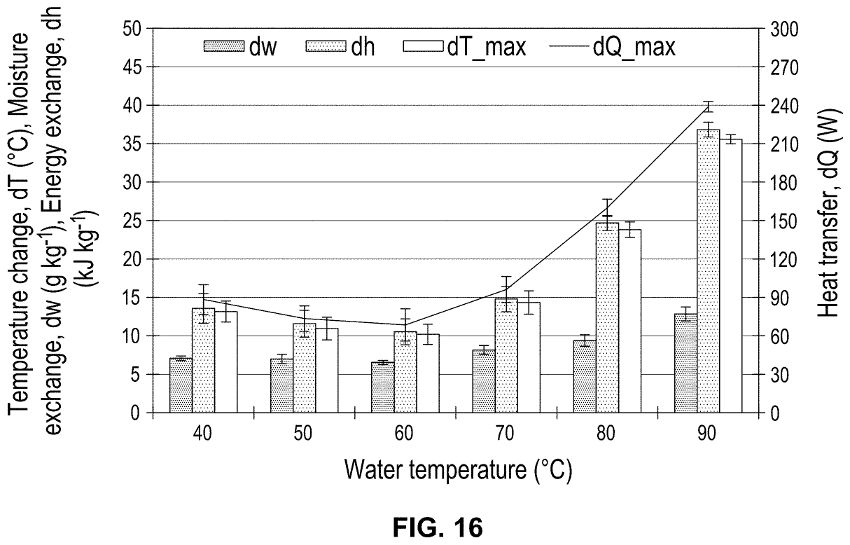

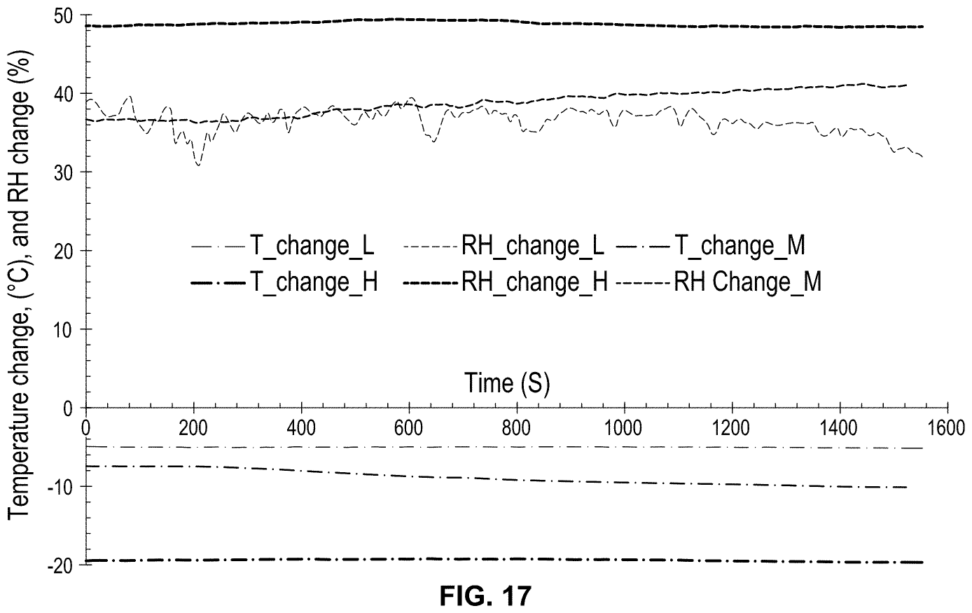

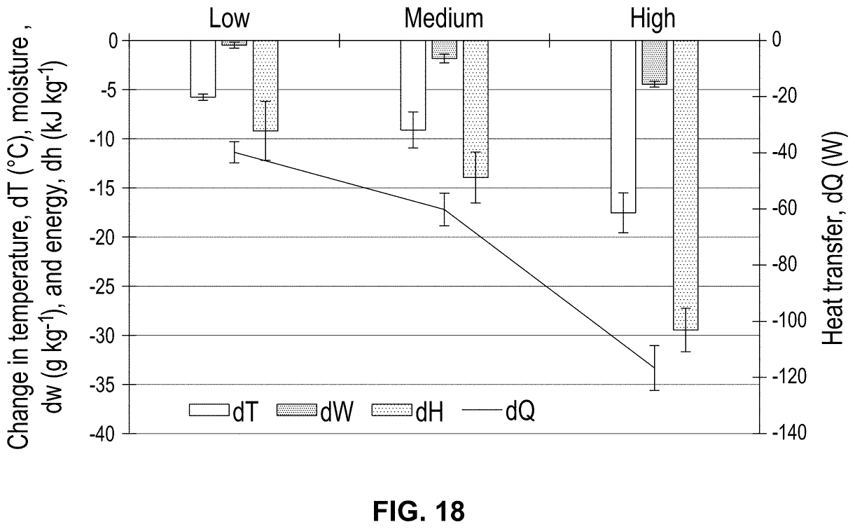

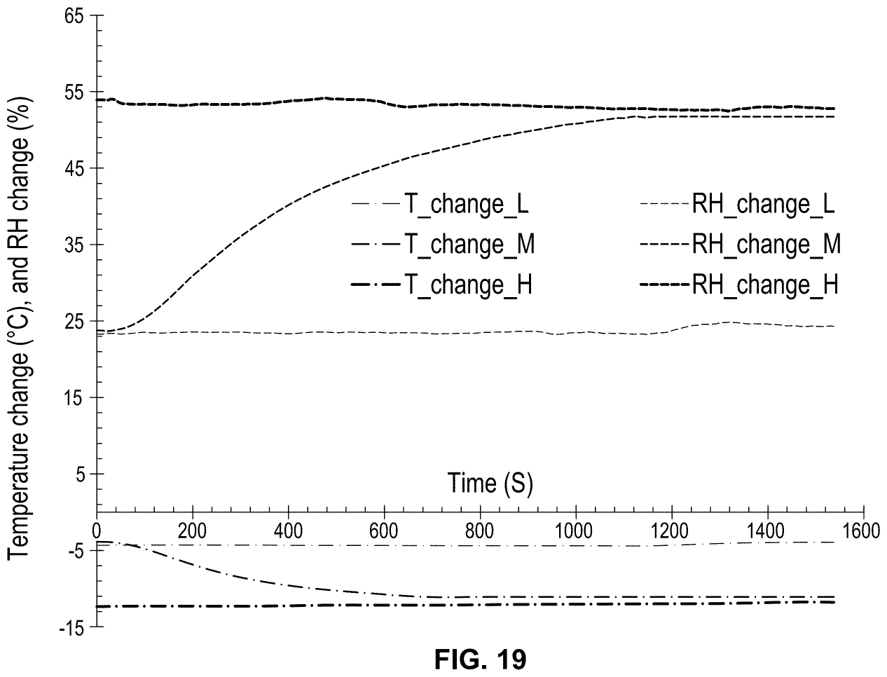

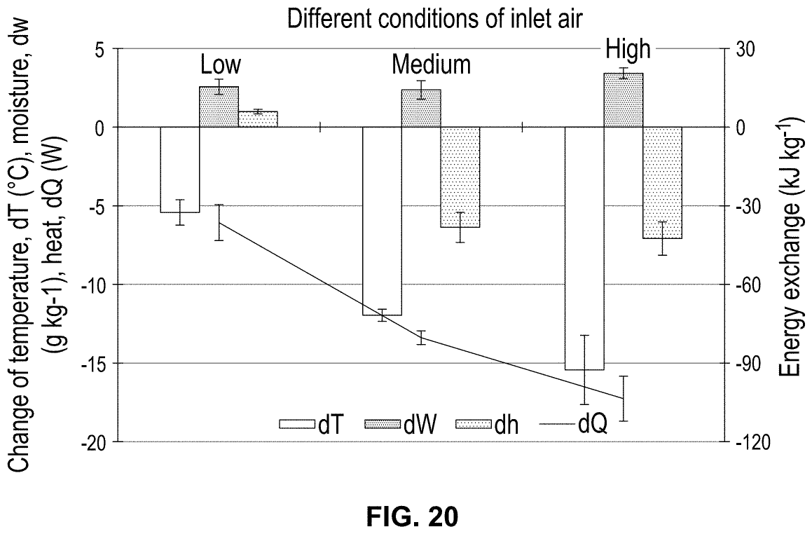

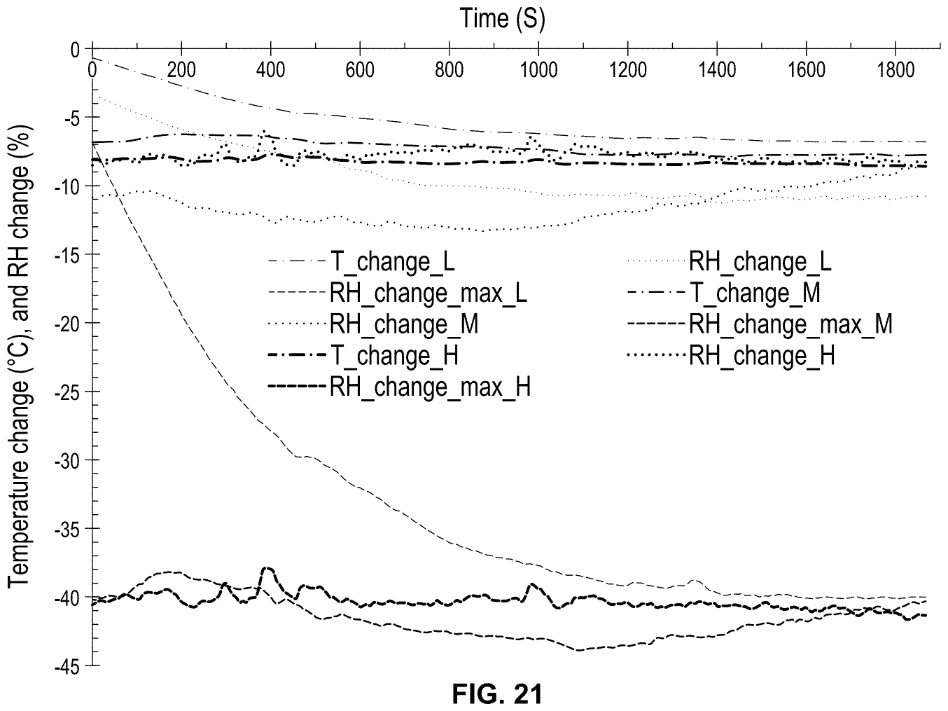

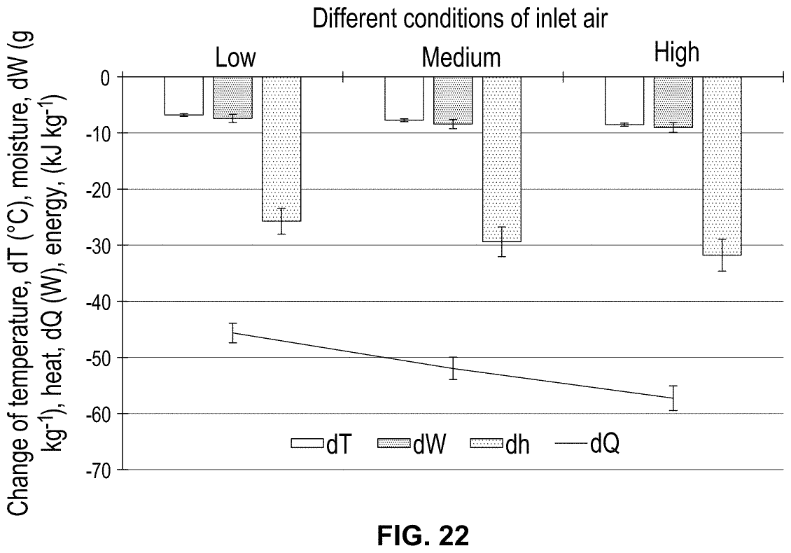

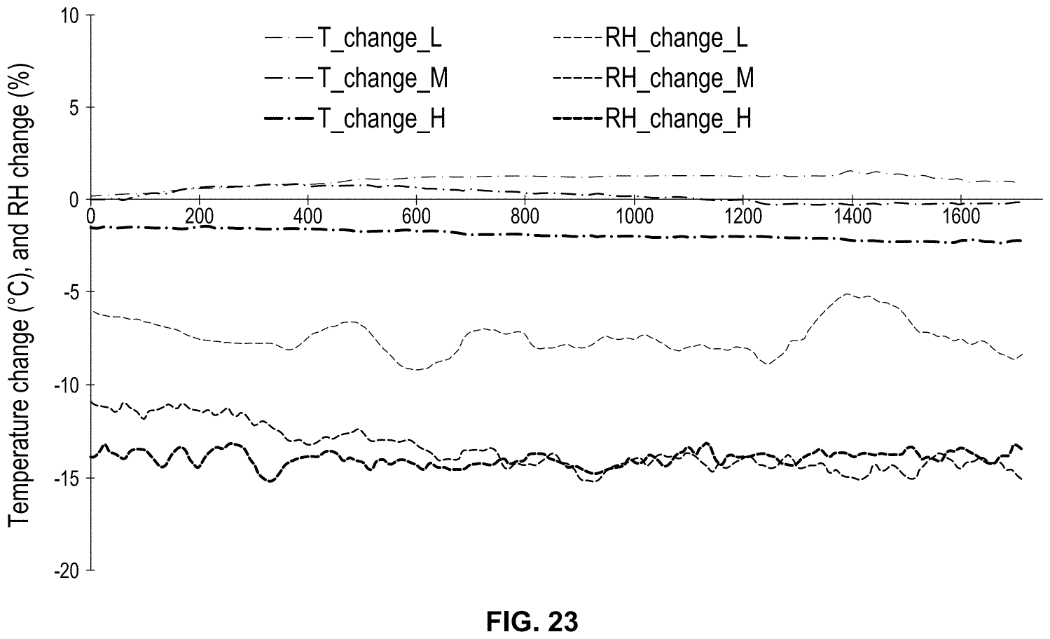

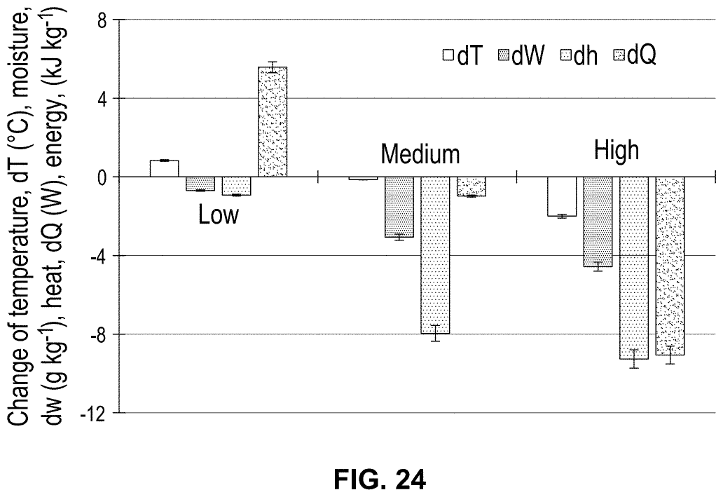

FIG. 10 is a graph showing the air temperature variation and observed humidification capacity of PC for samples 1, 2, and 3 of Example 1.

FIG. 11 is a graph showing the mass and energy transfer through PC samples 1, 2, and 3 of Example 1 during humidification.

FIG. 12A is a graph showing the dehumidification capacity of PC with low relative humidity (RH) conditions.

FIG. 12B is a graph showing the dehumidification capacity of PC with high RH conditions.

FIG. 13 is a graph showing the mass and energy transfer capacity of PC during dehumidification.

FIG. 14 shows photographs of the formation of a vegetation layer on PC in Example 2.

FIG. 15 is a graph showing temperature and humidity changes with the highest water temperature during heating tests of Example 2.

FIG. 16 is a bar graph showing the heat, mass, and energy exchange when heating with different inlet temperatures through vegetated porous concrete (PC). Mean values of heat, mass, and energy exchange for all tested vegetated PC cylinders with respective standard deviations are shown.

FIG. 17 is a graph showing changes in temperature and relative humidity (RH) when cooling with different inlet air temperatures through vegetated porous concrete of Example 2. L: low temperature (28° C. with 45% RH); M: medium temperature (31° C. with 42% RH); and H: high temperature (H; 37° C. with 40% RH).

FIG. 18 is a bar graph showing heat, mass, and energy transfer through vegetated porous concrete during cooling. L: low temperature (28° C. with 45% RH); M: medium temperature (31° C. with 42% RH); and H: high temperature (H; 37° C. with 40% RH).

FIG. 19 is a graph showing the temperature and relative humidity changes through vegetated porous concrete under different inlet air temperature and humidification conditions. L: low (25° C., and 65% RH); M: medium (34° C., and 48% RH); and H: high (37° C., and 38% RH).

FIG. 20 is a graph showing heat, mass, and energy transfer through vegetated porous concrete during humidification. L: low (25° C., and 65% RH); M: medium (34° C., and 48% RH); and H: high (37° C., and 38% RH). RH: Relative humidity.

FIG. 21 is a graph showing changes in temperature and relative humidity (RH) with different inlet air temperature conditions when monitoring dehumidification over 1800 s. L: low (23° C. and 90% RH), M: medium (25° C., and 87% RH), and H: high (27° C., and 85% RH).

FIG. 22 is a graph showing heat, mass, and energy transfer through vegetated porous concrete during dehumidification. Data represent mean values±SD. L: low (23° C. and 90% RH), M: medium (25° C., and 87% RH), and H: high (27° C., and 85% RH). RH: Relative humidity.

FIG. 23 is a graph showing the temperature and relative humidity (RH) during passive dehumidification when air is circulated through vegetated porous concrete. L: low (23° C., and 92% RH), M: medium (25° C., and 90% RH), and H: high (27° C. and 88% RH). RH: Relative humidity.

FIG. 24 is a bar graph showing heat, mass, and energy transfer through vegetated porous concrete without any external energy. L: low (23° C., and 92% RH), M: medium (25° C., and 90% RH), and H: high (27° C. and 88% RH). RH: Relative humidity.

### DETAILED DESCRIPTION

Embodiments presented below present an air circulation system comprising a concrete element being an open cell porous matrix concrete. The concrete element, for example a wall or a roof of an enclosed space has the double function of acting as part of the air circulation system and the building element. In some embodiments, the concrete can be or act as a heating, ventilation, and air-conditioning (HVAC) element, either directly from the design stage, or by retrofitting to an existing system. The enclosed space can, in some embodiments, be an enclosed dwelling space, an enclosed space for animal use, or an enclosed space for agricultural/plant growth use.

The term porous concrete (PC) as used herein refers to cast concrete having an open cell porous matrix that allows air to pass through the thickness of the concrete. The porosity can be inherent to the curing process taking into consideration the concrete recipe and previous mixing. PC can have a high thermal conductivity, high porosity, and high compressive strength. PC can be suitable a building element material. High thermal conductivity can allow the PC to carry heat from the heat source to room indoor air. High porosity can allow air to flow through the concrete with as a diffuser of a HVAC unit. Furthermore, the PC can be bio-receptive, allowing for germination and growth of vegetation on its exposed surfaces, with similar thermal and physical properties. In some embodiments, there is provided a green roof having the concrete element which acts as both a regular green roof in terms of mechanical, hydrological and thermal benefits, and a hydroponic green roof in terms of vegetative benefits.

Porous concrete (PC) can permit air and water transfer, while providing the necessary structural strength required for green building design elements. The high permeability and strength demonstrated by porous concrete (PC) emphasize its potential in different applications such as stormwater runoff control and soil erosion prevention. In some embodiments, a porous concrete element which exhibit a permeability of 2-6 mm s⁻¹ can be suitable for use as an element of a HVAC system. In some embodiments, the PC can have a porosity of between 15 and 40%, between 15 and 35%, between 15 and 30%, between 18 and 40%, between 18 and 35%, between 18 and 30%, between 20 and 35%, or between 25 and 35%.

Porosity is one of the primary factors that affects strength, heat transfer, permeability, and other major PC properties. The compressive strength of PC can decrease exponentially with increasing porosity, and the heat transfer rate of PC can decrease linearly with porosity, with a marked decrease corresponding to 40-50% porosity or more, due to a higher void portion than solid concrete. Overall heat transfer in PC with over 40-50% porosity is typically driven by convection heat exchange rather than conduction, due to more and/or larger void spaces than solid material connections inside the concrete element.

Although porosity is a primary factor that influences the strength of porous materials, concrete paste properties and the effect of compaction, w/b ratio, water reducing agent, and plasticizer in the PC production process can also be important. The compressive strength of PC further depends on pore size, pore connectivity, pore surface roughness, and admixtures. Alkali-activated slag can offer more compressive strength, but lower permeability and water absorption rate than all other typical binders (i.e. Portland cement) for the same w/b ratio and aggregate sizes, while demonstrating higher capillary sorptivity than Portland cement concrete. The thermal conductivity of PC generally increases with the w/b ratio value, but it can result in reducing the compressive strength of PC. The thermal conductivity of the binder itself (Portland cement: 1.1 W·m⁻¹·K⁻¹) is usually lower than the thermal conductivity of the aggregate (1.89 W·m⁻¹·K⁻¹). Moreover, the thermal conductivity of PC rises with the contact ratio between the aggregate particles. The directional dependency of thermal conductivity inside the concrete element can be highly dependent on pore tortuosity. Pore tortuosity defines the stability of the PC during use, and PC built using slag is more consistent in its chemical and physical structure than that made of fly ash. The strength can be improved along with thermal conductivity by using an optimum amount of superplasticizer (such as 0.65%) in the blend. However, large amounts of superplasticizer (>1%) further increase thermal conductivity but reduce the compressive strength.

Making reference to FIG. 1A, there is provided a system for circulating air 100 into and out of an enclosed space 104 through a thickness of a concrete element 102 having an open cell porous matrix concrete (also referred to herein as PC). The air circulation system 100 can be advantageously incorporated into a building structure (for example a concrete wall or a roof). A further advantage of the concrete element 102 is that it can be used to filter the air passing through it.

The air circulation is shown with arrows 112. The air flows out of the enclosed space 104 and into the air circulation conduit 106 to arrive at the fan 110. The fan 110 can be positioned adjacent to the outer surface 102a of the concrete element 102. The fan is configured to blow the air across the thickness of the concrete element 102 from the outer surface 102a to the inner surface 102b and into the enclosed space 104 as shown in FIG. 1A. In some embodiments, the thickness of the concrete element 102 is from 10 to 100 cm, from 15 to 80 cm, from 15 to 60 cm, from 15 to 40 cm, or from 20 to 40 cm. In some embodiments, a minimal thickness of at least 10 cm, preferably 15 cm, more preferably 20 cm, may be selected to ensure sufficient strength and structural support for an infrastructure containing the enclosed space 104.

As previously described, the concrete element 102 has an open cell porous matrix that can allow the flow of air without detrimental backpressure. In some embodiments, the pressure differential ΔP across the thickness of the concrete element 102 is in the range of 0.1 to 100 kPa, preferably 0.2 to 20 kPa. The pressure differential drives the air flow from the outer surface 102a to the inner surface 102b. In some embodiments, the air flow within the concrete element 102 is not a compressed air flow.

The air circulation system can include an external air inlet 114 that is in fluid communication with an external environment. The external environment is external with respect to the enclosed space 104. Accordingly, the external environment may be another space/room/area from the building of the enclosed space 104. In other words, in some embodiments, the concrete element 102 can be an internal wall of a building. In one example, the external air inlet 114 can be used to bring in fresh air into the air circulation conduit 100. The amount of air coming from the external air inlet 114 can be controlled or stopped using a valve 116. In some embodiments, the air circulation system 100 can include one or more filters. In one example, a filter can be placed between the fan 110 and the external air inlet 114 to filter the air coming from the external air inlet 114. In some embodiments, the concrete element 102 can be an external wall in contact with fresh air. In such embodiments, it is possible to remove or complement the external air inlet 114 and have an input of fresh air directly into the concrete element 102 (i.e. movement of the wind and/or differential pressure) by just having the fresh air being in contact with concrete element 102.

Making reference to FIG. 1B, the air circulation system 100 can further include a temperature control element 122 to impart or extract heat from the concrete element 102. In such embodiments, the air circulation system can complement or replace traditional heating systems in buildings. The temperature control element 122 modifies the temperature of the concrete element 102 (e.g. increasing heating, decreasing heating, increasing cooling, decreasing cooling). Accordingly, the air passing through the concrete element 102 can be cooled or heated thanks to the temperature control element 122. The temperature control element may be embedded within the concrete element 102 or can be partially or completely separate from the concrete element 102. For example, the temperature control element 122 can be a fluid circulation pipe, an electric heating element or a radiating heating element. The fluid circulation pipe can be configured to circulate a gas or fluid, for example an aqueous fluid such as water. The fluid circulation pipe may be disposed in a serpentine shape within the concrete element 102 to improve the heat exchange. The gas or fluid flowing in the fluid circulation pipe can provide heating and/or cooling. The electric heating element and the fluid circulation pipe can be at least partially, in some embodiments entirely, incorporated into the concrete element. The fluid circulation pipe can advantageously provide a heating fluid that has a temperature higher than the temperature of the concrete element and/or a cooling fluid that has a temperature lower than the concrete element 102. The radiating heating element can provide heat to the concrete element 102 through radiation and can thus do so from a distance and not be incorporated into the concrete element 102.

To control the temperature of the concrete element 102, the temperature control element can be coupled to a controller 126. The control 126 can for example be a computer. It will be understood that the expression “computer” as used herein is not to be interpreted in a limiting manner. It is rather used in a broad sense to generally refer to the combination of some form of one or more processing units and some form of non-transitory memory system accessible by the processing unit(s). The use of the expression “computer” in its singular form as used herein includes within its scope the combination of a two or more computers working collaboratively to perform a given function. Moreover, the expression “computer” as used herein includes within its scope the use of partial capacities of a processing unit of an elaborate computing system also adapted to perform other functions. Similarly, the expression ‘controller’ as used herein is not to be interpreted in a limiting manner but rather in a general sense of a device, or of a system having more than one device, performing the function(s) of controlling one or more device such as an electronic device or an actuator for instance.

It will be understood that the various functions of a computer or of a controller can be performed by hardware or by a combination of both hardware and software. For example, hardware can include logic gates included as part of a silicon chip of the processor. Software can be in the form of data such as computer-readable instructions stored in the memory system. With respect to a computer, a controller, a processing unit, or a processor chip, the expression “configured to” relates to the presence of hardware or a combination of hardware and software which is operable to perform the associated functions. FIG. 2 shows an exemplary controller or computer 400, receiving inputs that may be stored in a memory 414. The inputs are processed according to instructions 416 by a processing unit 412 to produce outputs which may be in the form of a signal, instructions or a material effect for a device or element coupled to the controller.

Returning to FIG. 1B, the controller 126 can be coupled to a first thermometer 120 that measures the temperature of the concrete element 102 and a second thermometer 118 that measures the temperature in the enclosed space 104. In some embodiments, the controller 126 can be or function as a thermostat. The controller receives an input from the second thermometer 118 and can determine whether the temperature in the enclosed space 104 is within a predetermined range. Like a thermostat, the predetermined range can be modified by a dweller of the enclosed space. If the temperature of the enclosed space 104 is below the predetermined range the temperature, the controller 126 can process such information and modify the temperature control element 122 to increase the heating provided and/or to decrease the cooling provided to the concrete element 102. In some embodiments, a temperature calibration curve is stored in the memory of the controller 126. The calibration curve can be determined by the controller 126 based on the enclosed space 104 or a standard calibration curve can be provided. The temperature calibration curve takes into account the heating efficiency of air passing through the concrete. In other words, if there is a need to increase the temperature in the enclosed space 104 by one degree, it may be required to heat the concrete element 102 by much more than one degree in order to provide appropriately heated air to regulate the temperature of the enclosed space 104. This relationship may not be linear hence the utility of a calibration curve to properly control the temperature in the air circulation system 100.

In some embodiments, the controller 126 is a thermostat. When the temperature in the enclosed space 104 becomes lower than the predetermined range, an electric switch of the thermostat closes thereby activating the thermostat to activate the temperature control element (a heating element in this case). When the temperature reaches the predetermined range the electric switch of the thermostat opens to deactivate the thermostat and therefore deactivate the temperature control element.

Making reference to FIG. 10, in some embodiments the air circulation system 100 can include a humidity control element 132. The humidity control element 132 can for example be a perforated circulation pipe embedded in the concrete element 102 and configured to circulate an aqueous phase through the concrete element 102. The humidity control element 132 can be coupled to the controller 126. In embodiments where the humidity and temperature control are combined, the air circulation system can be considered an HVAC unit. Advantageously, such HVAC unit can be incorporated into the element of the enclosed space 104 which can, in some cases, replace or complement traditional HVAC units.

As shown in FIG. 10, the air circulation system can contain a first hygrometer 130 configured to measure the relative humidity of the concrete element and a second hygrometer 128 configured to measure the humidity in the enclosed space. The first and second hygrometers 130, 128, can be coupled to the controller 126. In embodiments where the air circulation system 100 is an HVAC unit, the thermometers and hygrometers may be combined into a single instrument such as a thermo-hygrometer. The thermo-hygrometer can be coupled to the controller 126 and can provide an input containing the temperature and humidity readings.

The controller 126 can have a humidity calibration curve stored in its memory. The humidity calibration curve may be a standard calibration curve or a curve determined “on site” for the specific enclosed space 104 that the controller 126 operates for. Indeed, a calibration curve allows the control of humidity because the transfer of humidity is not a linear system. The pores in the concrete element have varying sizes. Indeed, smaller pores retain and release water differently than larger pores. Furthermore, the salt content in the concrete element 102 can vary with different recipe and environmental factors. This can affect the absorption/release of humidity from the concrete element 102. In addition, the surface of contact between the air circulating through the concrete element 102 and humidity can also vary depending on the pore sizes. A larger contact area generally leads to a faster and more efficient exchange of humidity (or temperature). In some embodiments, the calibration curves of temperature and humidity also depend on the presence and nature of a vegetation layer on the inner surface.

Making references to FIGS. 1D and 1E, a vegetation layer 134 with vegetation 140, can be provided on the inner surface 102b of the concrete element 102 to render the air circulation system 102 more environmentally friendly. Indeed, the presence of the vegetation layer may provide many advantages including the filtering of air passing through, the absorption of volatile organic compounds (VOC), providing oxygen and the vegetation layer can participate in the humidity exchange as well. To provide nutrients and water to the vegetation layer 134, the air circulation system 100 can further include a hydroponic unit 136 with a hydroponic circulation 138 to provide a hydroponic solution to the vegetation layer 134. However, in some embodiments, the hydroponic system can be a passive system.

Making reference to FIG. 1E, a concrete element 102 according to one embodiment is shown, where the hydroponic circulation 138 is also the humidity control element (i.e. a perforated pipe providing an aqueous phase to the concrete element 102 which acts as both the hydroponic and humidity fluid). In some embodiments as shown in FIG. 1E the temperature control element 122 can be a fluid circulation pipe.

In the air circulation system, the extensive mechanical and physical properties of PC, along with plant-growing capacity permitted through easy access to air, water, and nutrient solution, show the advantages of the air circulation system for use in a green building envelope with environmental control. In some embodiments, a bio-compatible PC mix adapted to enhance plant-growing capability and structural functionality, with optimized porosity, permeability, pH, and mixture additives, can be used. This bio-compatible mix can also have the temperature and relative humidity (RH) control discussed above and the features associated thereto.

With respect to its plant-growing capacity, PC is a suitable growing substrate in the field of hydroponics. The higher porosity and permeability of the bio-compatible PC can efficiently deliver air and nutrient solution to plant root systems. Hydroponic substrates are typically used in controlled environment agriculture where the plant's growing temperature and relative humidity is controlled. In some embodiments, the PC can be considered a growing substrate that can control its own temperature and moisture content which is advantageous for growing vegetation.

When growing vegetation on PC the alkalinity (pH) and sodic characteristics of the PC can be selected depending on the species of vegetation to be grown on the PC. Advantages of using PC as the growing substrate for vegetation includes its reusability and non-adverse disposal after its use. In some embodiments, the pH inside the PC is below 10 to promote the development of the vegetation layer, the pH can preferably be within a range of 5.5-8.5 depending upon species for plant growth. Moreover, the PC can have suitable porosity to allow the growth of plant roots in the concrete element, and suitable strength and porosity to hold the concrete element together during root expansion.

PC can be an appropriate plant-growing substrate, with a cooling capacity suitable for plant propagation in outdoor temperatures of up to 45° C., and suitable for the root system where the temperature may be controlled to around 30° C. In some embodiments, PC has the capability of retaining heat (18-28° C.) even at −20° C., and the PC can maintain a temperature above freezing when the outdoor temperature is as low as −35° C. Moreover, in control environment agriculture, PC may enhance crop-growing capacity as a reusable and self-controlled hydroponic growing substrate. Benefits of including a vegetation layer on the PC include improving indoor air quality and proportionally reducing outdoor fresh air intake. In some embodiments, less than 20% of external air is provided in the HVAC system, preferably less than 10%. In some embodiments, a completely closed system, or a pseudo closed system (occasional external air intake) can be achieved thanks to the vegetation layer. This reduction in external air intake can result in significant cost savings in heating or cooling depending on the seasons.

FIG. 1F shows an exemplary non-limitative embodiment of the air circulation system in a green building. Green building technology can partially mitigate the adverse effects of urbanization by controlling stormwater runoff, pre-filtering water, minimizing climate change outcomes, and reducing heat island effects. The interior green technologies may improve the air quality and provide aesthetic benefits to the occupants. The current green building technologies are hindered by high cost and mass, less crop production capability, and incorporation of large amounts of polymers. Additionally, the green walls and green roof was considered as an extra loading component with the main structure. In hydroponic green structures, the plant growing systems require special setups, maintenance, and frequent replacement of plant-growing substrate, with limited energy savings in the heating and cooling load of the building due to the space between the main structure and the hydroponic setup, which make the system less attractive to green builders. However, an improved exemplary vent-zero building design is presented in FIG. 1F. The concept “Vent-zero” is similar to “Net-zero” building, where the net ventilation or emission from the building can fully or partially be recovered by the building itself. The porous concrete integrated novel green roof and green wall can be incorporated in this vent-zero building, where the concrete acts as a plant growing substrate as well as a structural component. The closed-loop ventilation system may be implemented with an inner surface-planted environmentally controlled green wall that can control the air quality (temperature and humidity) without ventilating fresh air from the outdoor environment. The Vent-zero building may help offset the effects of urbanization by providing stormwater and pollution control, runoff delay, and physical and thermal benefits through its roof, and air quality with full HVAC control through its wall, and concurrently can produce biomass from a reusable substrate. In some cases, the Vent-zero building can extremely reduce (tend to zero) the fresh air exchange for HVAC control of that building. Without wishing to be bound by theory, this may be because (i) the exposer/contact of hydroponic solution with recirculating air does not contaminate the indoor air, (ii) a regular fan is adequate to recirculate air through the close loop, and (iii) the physical and thermal properties of PC are substantially uniform through its structure, and may substantially remain constant.

The Vent-zero building exemplified in FIG. 1F can have dimensions of 1.2×1.2×1.5 m³. Two green walls (90×60×11.5 cm³) can be placed as sidewalls with plants growing on the interior. The green roof (1.2×1.2 m²) can be covered with a flexible and transparent extreme weather protection shade that is used to measure its storm water controlling capacity. Lettuce and grass may be germinated and grown hydroponically on the roof and walls. The pump and hydroponic solution can be connected as a close loop system, and also provide humidity to the concrete element.

Two blower fans can be incorporated to push air through the wall to the room. The fresh air mixing system can be incorporated to add fresh air, if needed. Air is recirculated through the vegetated green wall, and the vegetation layer thus provides fresh and breathable air without any external fresh air intake. The green roof may be strategically placed to the reduce heating and cooling load of the building.

The Vent-Zero system described herein and illustrated in FIG. 1F reduces the fresh air exchange without affecting the environment and air quality inside the building. Side walls can work as an overall HVAC system with natural air purifying capability (vegetation layer). The green roof can also provide high stormwater control and runoff delay with or without plants and can add biodiversity to the area. HVAC energy consumption in the Vent-zero system may thus be reduced significantly.

### Example 1: Air Circulation Through Porous Concrete

Three identical and cylindrical PC samples (samples 1, 2, and 3) were cast with an exact water/binder (w/b) ratio of 0.2. Blast furnace slag was used as the main binder with water glass and sodium hydroxide as activator. CEMEX Pervia™ technology was chosen to manufacture the three cylindrical PC samples with the same dimensions (11.5 cm height and 15.24 cm diameter) and properties (specific gravity of 1.77 and 25% porosity), which were hand-packed into cylindrical cardboard molds with an exact water-binder ratio of 0.2. Selected type of aggregate (Quarzsand, 2-3.2 mm) was used to build the samples with CEMEX Vertua™ binder technology. The Pervia™ PC mix compositions and amounts are given in Table 1. PC mixing, packing, curing, and other casting processes were conducted following the standard procedure developed by CEMEX Global Research and Development for cement-free porous plant growing substrate. Three plastic pipes forming Z-shaped coils (FIGS. 3A-3D) were placed in each cylindrical PC sample during casting. Two coils made of polyethylene (PE), with a thermal conductivity of 0.38 W m⁻¹ K⁻¹, were used for heating and cooling at both sides of the cast PC cylinders. These pipes were 105 cm in length, had an outer diameter of 0.635 cm, an inner diameter of 0.432 cm, and 1 mm perimetric thickness. In the present example, the first coil was termed the “back coil,” and the second (outer) coil was termed the “front coil”, following the direction of the airflow. The third pipe consisted of polyvinyl chloride (PVC), with a thermal conductivity of 0.19 W m⁻¹ K⁻¹. This pipe had an inner diameter equaling 0.31 cm, and it was placed in the middle of each PC cylinder to flow water through it. The PVC pipe (105 cm long) was uniformly perforated at 2.5-cm intervals with pinholes to disperse water inside the PC under pressure. The front, back, and water coils were evenly placed 2.5 cm apart from each other (FIG. 3B).

TABLE 1
Pervia ™ PC mix constituants

| Items | Materials | mass/2 Liters | |
|---|---|---|---|
| Aggregate | Quartz 2-3.2 mm | 3.2 | kg |
| Vertua ™ binder | Mix of binder and | 496 | g |
| | admixtures | | |
| Mixing agent | Water | 0.078 | kg |

The experimental setup is shown in FIG. 3D. A hydroponic pump (PonicsPump-PP29105, PhonicsPumps, US) with 0.01 m³ s⁻¹ capacity was used to supply water to the PC. A heated water bath was used to supply hot water (up to 90° C.) at a flow rate of 23 mL s⁻¹. For cold water, an ice-bath was used to attain a water temperature of 1-2° C., with the same flow rate. Water at room temperature (20-22° C.) was circulated through the water pipe for controlling moisture content into the PC sample. The PC cylinder was connected to an air-flowing duct with the same diameter (15.24 cm) (FIG. 3D). The air duct was connected to three centrifugal fans connected in parallel, which provided a specific airflow capacity (0.00668 m³ s⁻¹) and an air velocity of 0.3 m s⁻¹ through the PC. The heating system, cooling system, and other accessories were connected to the setup to provide a range of supply air temperatures to the PC cylinder. A domestic space heater (Stanley: 675919C, Stanley black & Decker Inc., Towson, Md., US) of 1500 W capacity provided hot air, and the cold outdoor air was used directly for cold airflow through the PC. Temperature, humidity, and pressure sensors (Adafruit: BME680, Adafruit Industries, New York, N.Y., US) were placed before and after the PC cylinder. A digital hot wire anemometer was used to record the flow velocity of air through the PC sample; it also provided an air temperature reading.

Data was collected using a Python-coded automatic data logger connected to two temperature and humidity sensors that were placed before and after the cylindrical PC sample (FIG. 3D). Temperature, pressure, and RH data were recorded at 7-s intervals during testing. The sensor errors was ±0.5° C. for temperature data and ±3% in for RH data. During heating tests, the hot water temperature was varied from 40° C. to 90° C., at 10° C. increments. The heat transfer rate was calculated by measuring the temperature of inlet and outlet air. For cooling tests, the ice bath was held at 2° C. to circulate the water, and the incoming air temperature was varied from 17° C. to 50° C. During the humidification tests, water was uniformly provided to the PC cylinder using a hydroponic pump, and the air temperature was varied from 17° C. to 50° C. The wet PC cylinder provided outlet air with a high RH, and moisture exchange was calculated by using inlet and outlet RH data with air flow rate. For dehumidification tests, humid air was created separately and passed through the PC samples. The cooling system was enabled, and water flow turned off during dehumidification effect testing.

During heating tests, hot water was supplied from the heated water bath through the front coil, back coil, and both coils together. The water supply temperature was controlled by the heating bath. The air flowed through the PC was perpendicular to the water flow inside the PC. The experimental apparatus heated the cold air, and the heat exchange rate through the PC (between water and air) was calculated from the inlet and outlet temperature of the air (Equation 1.1):

Q=\dot{m}cₚΔT (1.1).

Where Q=heat exchange inside the concrete (W), \dot{m}=mass flow rate of air inside the concrete (kg s⁻¹), and the air temperature difference was calculated (Equation 1.2) as follows:

ΔT=Tₒᵤₜ−Tᵢₙ((+ve) in heating, and (−ve) in cooling) (1.2);

where Tₒᵤₜ is the outlet air temperature (° C.), and Tᵢₙ is the inlet air temperature (° C.).

The mass transfer rate was calculated from the RH change in inlet and outlet air. The dry air of two different temperatures (low and high) was followed through the cylindrical PC sample to monitor the moisture transfer rate. The moisture transfer rate was calculated as follows (Equation 1.3):

ΔW=\dot{m}×(wₒᵤₜ−wᵢₙ) (1.3);

where \dot{m} is the mass flow rate of air (kg s⁻¹), and wₒᵤₜ, and wᵢₙ are the humidity ratio (g kg⁻¹) before and after the PC block. Temperature and RH were measured before and after the PC cylinder, and the humidity ratio was calculated from that temperature and RH readings with the help of the psychometric relationship (Equations 1.4, 1.5, and 1.6):

$${p}_{s} = 0.611 \times Exp ( \frac{17.27 \times T}{237 + T} ) ; \qquad ( 1.4 )$$

$${p}_{i} = {p}_{s} \times RH ; \qquad ( 1.5 )$$

$${w}_{i} = 0.62198 \times ( \frac{{p}_{i}}{p - {p}_{i}} ) ; \qquad ( 1.6 )$$

where T=air temperature (C), pᵢ=partial pressure of water vapour in air at any RH, (kPa) pₛ=partial pressure of water vapour in air at saturation, (kPa) and p=atmospheric air pressure (101.325 kPa). A large quantity of latent heat was transferred with the moisture transfer on the air. Therefore, apart from the sensible heat and mass transfer, the total energy transfer was estimated by calculating the change of enthalpy in the air in Equation 1.7:

Δh=hₒᵤₜ−hᵢₙ (1.7);

where hₒᵤₜ and hᵢₙ are the total energy (enthalpy) of outgoing air and incoming air of concrete, respectively. Enthalpy was calculated as follows (Equation 1.8):

h=(1.006×T)+w(2501+1.805×T), (1.8).

For Equation 1.7, if the energy is transferred from water to air, the change of enthalpy becomes positive, and if the energy is transferred from air to water the change in enthalpy is negative.

Statistical analyses were performed to verify reproducibility and trend similarities for each PC sample when determining heat and moisture transfer capacity. For heating, reproducibility of heat transfer rate was analyzed among all three PC samples at each temperature increment with a double coil arrangement. For cooling, reproducibility between PC samples was verified for each coil arrangement. For humidification and dehumidification, reproducibility of the mass transfer rate for all three PC samples was analyzed at the same inlet air temperature level (low, middle, or high). Reproducibility was verified by calculating the variance and root mean square error (RMSE) between all data using Equations 1.9, 1.10, and 1.11:

$$Mean , μ = {\sum }_{i = 1}^{N} \frac{{S}_{i}}{N} \qquad ( 1.9 )$$

$$Variance , Var = {\sum }_{i = 1}^{N} \frac{{( μ - {S}_{i} )}^{2}}{N - 1} , \\ and Standard deviation , σ = \sqrt{Var} \qquad ( 1.1 )$$

$$and , RMSE = \sqrt{( {\sum }_{i = 1}^{P} \frac{{Var}_{i}}{P} )} \qquad ( 1.11 )$$

Where, Sᵢ is the i^{th} sample's value of the measured parameter, N is the number of samples, and P is the number of measurements. The agreement of all results and their common trend were estimated by calculating the coefficient of determination (R²) regarding respected changes. The R² value was calculated as follows (Equation 1.12):

$${R}^{2} = {( \frac{{\sum }_{i = 1}^{P} ( {M}_{i} - \overline{M} )}{\sqrt{( {\sum }_{i = 1}^{P} {( {M}_{i} - \overline{M} )}^{2} )}} )}^{2} ; \qquad ( 1.12 )$$

where Mᵢ is i^{th} measurement, and M is the average for all measurements. Similarly, Equations (1.9-1.12) were used to calculate the reproducibility of heating, cooling, humidification and dehumidification capacity data for all PC samples.

PC's potential as a building material for green roofs or walls with HVAC control was investigated by heating, cooling, humidifying, and dehumidifying the air as it passed through a PC cylinder.

Heat transfer tests were conducted by changing the temperature of hot water flowing through polyethylene piping embedded in the PC Sample. Results are discussed for water temperature variation and coil position variations as follows.

To determine the heating capacity of the PC, the temperature of the water passing through the piping was varied with 10° C. increments. The outlet air temperature of the PC increased sharply during heating, following incremental increases in water temperature (FIGS. 4A-4C). The temperature changing capacity of PC Samples are found at a maximum from 26±2° C. to 50±2° C. In general, the output air temperature increased proportionally with the hot water temperature. The heating effect was minimal when the PC sample was provided with heated water of 40° C., and outlet air temperature increased only 4-5° C. When PC was provided with hot water of 90° C., PC Samples provided an outlet air temperature of 50±2° C.

The overall heat transfer capacity of all three PC samples is shown in FIG. 5. PC Samples showed the highest heat transfer rate of 150.0±3.5 W. Before heating with hot water at 70° C., the outlet air temperature rose 5-7° C. (varying from sample to sample) for every 10° C. change in hot water temperature. After 70° C. the outer air temperature rose 9-11° C. for every 10° C.-increment of hot water temperature, and this transition point was not precisely at 70° C. for all samples. This transition might due to the change in heat transfer mode.

Coil arrangement noticeably affected the inside temperature of PC and profile of output air temperature. For every PC sample, three coil arrangements were tested using three different heating methods in order to find the optimum coil position. When the double coil system was heated with hot water at 90° C., the maximum temperature reached for PC Sample 3 was 53.2° C., resulting in the highest heat transfer rate (152.3 W). With the front coil system, PC Sample 1 provided a maximum temperature of 32.3° C., with a maximum heat transfer rate of 85.01 W. With a back coil system, PC Sample 3 provided a maximum outlet air temperature of 39.7° C., with a heat transfer rate of 89.35 W. PC Samples exhibited similar heat transfer rates with the same coil arrangement. The stepwise increment of hot water temperature is clearly demonstrated by a stepwise bounce in outlet air temperature for all PC samples (FIGS. 6A-6C).

When considering time-lapse, the front coil system showed a quicker response than back coil heating with increasing outlet air temperature. With the back coil system, the temperature was 3-5° C. lower at the beginning (when water was 40-70° C.), but at the final temperature, both coil arrangements were within 95% of their respective values. The heat transfer capacity of each PC sample at different water temperatures is shown in FIG. 7. In double coil arrangement, the maximum difference in heat transfer rate between samples is 5.85 W, representing only 3.84% of the maximum value (152.3 W). Accordingly, with back coil heating, the difference was approximately 9.24%, and for front coil heating, the difference was approximately 18.3%.

Cooling capacity was determined by varying input air temperature. During cooling tests, the cooling fluid (ice water) temperature was kept constant at 2° C. and air was provided at three different temperatures ranges (low level: 20-23° C.; mid level: 29-31° C.; high level: 48-50° C.) to compile heat transfer profiles. Temperature and heat transfer rate profiles for all PC samples were measured using the same procedure as the heating tests. The temperature and heat transfer rate profile of PC Sample 2 is presented in FIG. 8 to demonstrate changing trends for both parameters. PC Samples 1 and 3 were comparable to PC Sample 2, and overall heat transfer rate of every PC sample is presented in FIG. 9. When cooling, heat flowed from hot external air to the PC, and then from the PC to the cold water. A maximum heat transfer of −104.3±5.2 W was observed with an input temperature at 45-50° C. At an input temperature of 49.5° C. (high level) and cooling with a double coil arrangement, the PC cooled the air down to 34° C., resulting in a temperature decrease of 15.5° C. The heat transfer rate changed to −52.1 W and −74.72 W when the inlet air flow rate is at 24.5° C. and 34° C., respectively. When the temperature difference between air and water was 22.5° C., the PC reduced the air temperature up to 8° C. When the temperature difference between the water and the air temperature was 30.5° C., the PC reduced the air temperature by up to 11° C. All negative values for the heat transfer rate indicate the energy-absorbing behavior of the PC from the air. These data indicate that the heat absorption rate of PC rises with the temperature difference between the air inside the PC and the temperature of the cooling fluid.

The RH changing capacity at different temperatures is presented in FIG. 10. The temperature variation for PC Sample 1 (S1) was within the room temperature range (17 to 27° C.), yet for PC Samples 2 (S2) and 3 (S3), the temperature varied from 22-50° C. The inlet air conditions were changed stepwise with increasing time which is named as treatments in FIGS. 10, and 11. The temperature and RH condition changing in inlet air caused a large variation in heat and mass transfer capacity of PC samples. PC Sample 1 has the variation until 27° C., it mostly provided on average of around 95% RH with a mean temperature reduction of 9.5° C. between the inlet and outlet sides. In PC Sample 2, variations were linear, and RH decreased with an increase in temperature. At the low-temperature range (<30° C.), PC Sample 2 provided maximum RH (99%) in the outgoing air, and on average, provided approximately 94% RH even at high temperatures, up to 50° C. However, PC Sample 3 had an average RH of 83%, with a 12.7° C. decrease from inlet to outlet air. The lesser RH changing capacity of PC Sample 3 justifies its high heat transfer capacity; however, differences were less than 10% in terms of total energy transfer.

The total moisture and energy transfer inside all PC samples over time are shown in FIG. 11. In terms of mass transfer, PC Samples showed the maximum capacity of 8.53±1.2 g kg⁻¹. However, PC Sample 1 showed the lowest mass transfer (6.53 g kg⁻¹) as was tested at a low-temperature range (17-27° C.), whereas PC Samples 2 and 3 were tested at both low and high temperatures ranges (22-50° C.). The maximum energy transfer of the PC sample was found as 6.18±0.59 kJ kg⁻¹.

Dehumidification proved the most challenging thermodynamic process for the PC samples, because PC has a tendency to hold water when it comes in contact with humid air. Only cooling dehumidification data was attainable, and the average dehumidification capacity of PC at low RH and high RH is shown in FIGS. 12A-12B. The dehumidification capacity of PC is almost zero if the inlet air RH is less than 40%.

During cooling dehumidification, moisture was removed as condensate with saturated cold air as the output. Since the cooling was continuing, the outgoing air was always colder than the incoming air. During low RH dehumidification, the temperature change was, on average, approximately 8.3° C., whereas during high RH dehumidification, the temperature change was approximately 4.8° C. Therefore, a better method for observing the effect of changes in RH is to calculate the adjusted RH at the same temperature as the inlet. The adjusted RH showed a maximum RH decrease of 12%, and 29% for low and high RH air inlet, respectively.

The energy and mass transfer profiles at low and high RH conditions are shown in FIG. 13. Both profiles show similar trends, including adjusted RH transfers in both the low and high RH air inlets. With a low RH air inlet, the maximum mass and energy transfer obtained were −3.37±0.56 g kg-1, and −17.54 kJ kgair-1, respectively, and for the high RH air inlet, −5.14±0.56 g kg-1, and −17.51 kJ kg-1, respectively.

The reproducibility of data between all PC samples were compared for every experimental condition. A comparison summary is presented in Table 2, where the range of standard deviation for all experiments indicates the minimum to maximum error in results between all specific cases.

TABLE 2
The calculation of statistical parameters
for experiments between all PC samples.

| | Maximum | Standard | | |
|---|---|---|---|---|
| Experiment type | value | deviation | RMSE | R² |
| Heating (W) | 152.3 | 1.7-6.7 | 5.01 | 0.98 |
| Cooling (W) | −114.2 | 5.2-6.4 | 5.91 | 0.82 |
| Humidification (g kg⁻¹) | 12.5 | 0.048-1.2 | 0.45 | N/A |
| Dehumidification (g kg⁻¹) | −6.1 | 0.13-1.0 | 0.55 | N/A |

The reproducibility of heating capacity data between all PC samples was verified by their heat transfer rate at different hot water temperatures. The RMSE between all samples was 5.01 W, and the standard deviation varied from 1.7-6.7 W, and both of these values are less than 5% of their respective maximum values. All three samples agreed to the increasing trend in which the heat transfer rate increased with a coefficient of determination (R²) value of 0.98.

In cooling, the repeatability of heat transfer rate was observed for all samples with respect to their different coil positions, as the repeatability of heat transfer was checked for different temperatures during the heating test. Mean values of heat transfer for all conditions were compared in this statistical analysis, and the results are presented in Table 2. All samples provided similar cooling heat transfer with an RMSE value of 5.91 W, and standard deviations values of 5.2-6.4 W. Both of these values were less than 5% of their respective maximum values, so the samples showed repeatability in their cooling capacity. All samples adhered to changing trend of heat transfer rate from one position to another (R²=0.82).

The repeatability of moisture exchange in all samples was checked for the temperature range of 26-27° C., as only in this temperature range all three samples are comparable. The measurement shows a consistent moisture exchange of 6.45 g kg⁻¹ in that 1° C. temperature change. The RMSE was 0.45 g kg⁻¹, approximately 5.66% of its maximum value (7.94 g kg⁻¹). The standard deviation of measurement between all three samples varied from 0.048-1.2 g kg⁻¹, 0.6-15% of the maximum value of moisture exchange.

In dehumidification, all PC samples provided comparable dehumidification capacities depending upon the inlet air RH. The reproducibility of dehumidification data was further verified for high RH inlet air within a temperature range of 20-21° C. Statistical analyses demonstrated that the dehumidification capacity of PC was constant within one degree of temperature change. Data indicate a consistent moisture reduction rate of 4.57 g kg⁻¹ within the tested temperature range. The RMSE was 0.55 g kg⁻¹, within 10% (9.1%) of its maximum value (6.1 g kg⁻¹), and the standard deviation was 0.13-1.0 g kg⁻¹, within 1.5-16% of the maximum value of moisture exchange.

Heat transfer inside PC happens by both conduction and convection. The heating inside PC changed the outlet air temperature by only 4-5° C. when heated with 40° C. water, but approached 50° C., when heated with 90° C. hot water. It is possible that when the water temperature was heated to 40° C., the PC might use most of the heat to overcome its heat reluctance within its structure, and the small temperature difference between the water and air does not provide enough of a temperature gradient to obtain a high heating effect. For water heated at 40-70° C., the heat transfer slope is comparatively flat. This could be because convection heat transfer may contribute more than conduction, as conduction is only effective when a significant temperature gradient exists between grains. Since the air was continuously flowing at 0.3 m S⁻¹ through the PC, at a temperature of 40-70° C., the PC might not get enough heat to become hot quickly, as it can transfer heat from grain to grain by conduction. For temperatures ranging between 70-90° C., the heat transfer profile shows a comparatively sharper increment, likely due to more conduction transfer than convection. At a high temperature, the PC becomes hot and transfers more heat from the heating pipe to the air due to PC's internal conduction. Maximum temperature readings represent the capacity of each PC sample, and the temperature variation is only from different incoming air temperatures.

The difference in temperature between different heating methods is likely due to the coil arrangement inside each cylindrical PC sample and heat transfer characteristics of the PC. With a back coil arrangement, the coil had to heat up the whole PC cylinder first, through both conduction and convection, and then heat was transferred to the outlet air. For the first few water temperature increments (up to 70° C.), the outlet air of the back coil arrangement provided a 1-4 W lower heat transfer rate than that of the front coil arrangement. This difference is within 5% of their respective values. At high heat (70-90° C.), the back coil provided a similar or higher heat transfer rate than the front coil, likely because in previous heating steps, the PC sample was getting heated up and released its own heat at the last steps of heating.

With the front coil arrangement, the heating effect started at the last third portion (following airflow direction) of the PC because of the coil's position. As the air continuously flowed through the PC, heating at lower temperatures (up to 70° C.) PC only used conduction for its own heating, and convection directly goes out to the outlet air. Therefore, there was no convection heat loss due to leakage through the earlier portion of the PC. With the double coil arrangement, both coils contributed to the heating effect and the PC was uniformly heated to transfer heat to the outlet air.

During cooling, temperature decreased proportionally, or the cooling rate increased proportionally with the temperature difference between inlet air and cooling water. Since the cooling water was at constant temperature of 2° C., maximum heat absorption happens at the coil point in the PC sample, and the whole cylindrical PC sample did not cool uniformly. Moreover, as the cooling water was not able to cool down the PC sample to its own temperature, there was always a high-temperature gradient between the grains causes conduction with convection within the PC samples.

The heat transfer rate decreased from the front coil to the back coil, likely due to the internal reluctance of the PC's self-heating. When the PC was cooled with the back coil, cooling water took a longer time to absorb heat from the rest of the PC cylinder. Within that time, the remaining two-thirds of the PC cylinder gained heat from its surroundings through the periphery, similar to heat loss during heating, as the room temperature was at 22° C. PC also provided internal cooling reluctance because of its own heat storing capacity. The heat absorption rate increased linearly with the airflow temperature, as both the convection and conduction heat transfer are proportional to the temperature differences of the transfer fluids (water and air).

Humidification or mass transfer solely depends on the air-accessing capacity or permeability of the PC. Humidification was conducted by distributing water directly inside the PC sample with perforated piping. When the water inside the PC evaporated, it reduced the temperature of the outgoing air as latent heat of evaporation was taken from the air. Therefore, the outgoing temperature for PC samples was 10-13° C. lower than the respective incoming air temperature. That temperature difference was a measure of moisture evaporation inside the PC, because that total heat loss of air is just utilized in evaporating water inside the PC. Therefore, a greater temperature difference indicates greater moisture evaporation, as well as higher humidification capacity of the PC.

Theoretically, all PC samples should provide the same mass transfer rate as all samples were designed and mixed for identical porosity. However, PC sample 1 showed the lowest mass transfer as it was tested with low temperature inlet air. The difference in energy transfer is approximately 8.3% between PC Sample 2 and PC Sample 3. The mass transfer difference between samples is likely because of internal convection current. Because, with the same porosity and structure, a highly permeable sample provides more mass transfer than low permeable sample. It is possible that the inner structure of PC Sample 2 might be more convective than PC Sample 3, resulting in more mass transfer and less heat transfer, but with comparable overall energy transfer to PC Sample 3. This inner structure difference might exist, as the samples were cast by hand packing, and it was difficult to keep the coil position exactly at the same position in all three samples.

The moisture from inlet air was removed by cooling and condensation. In cooling dehumidification, the air at the cooling coil position always was at the saturation point inside the PC sample. In this experiment, the change in RH was minimal and even negative for some conditions when low RH (<40%) inlet air is provided to the PC samples. When the PC was completely wet after operating for a long time, existing cooling could not bring air to its dew point to start condensation for the existing moisture present in the air. Moreover, when the cold air was passing through the completely wet PC cylinder, it became more humid but not condensed, resulting in greater moisture instead of dehumidification at some points. However, this was only observed in the low RH range (<40%) with completely wet condition of PC, and after a long dehumidification run. Thermodynamically, dehumidification was still possible at these points, but more cooling would need to be added. Some additional changes are required to the experimental setup to attain that effect. It is important to note that most HVAC systems do not require dehumidification in that low RH range, and dehumidification does not work effectively if there is a continuous flow of water inside the concrete.

Dehumidification was not consistent in the low RH range, because the PC became wet once the dehumidification rose to its peak capacity, and the dehumidification capacity decreased linearly along with the energy transfer rate. Within the high RH range, the dehumidification capacity was consistent with energy transfer, because the cooling temperature was mostly lower than the due point of inlet air. The mass and energy exchange curve showed a downward bump which may due to small leakage through the periphery of the PC sample. The mass and energy transfer fluctuation may also happen due to the non-uniformity of cooling inside the concrete, and some portions of PC non-uniformly wetted due to the condensate of cooling coil surface. Due to the high RH in the inlet air, moisture saturation occurred with a small change of temperature, which was difficult in low RH air inlet. These analyses clarify the maximum dehumidification capacity of PC samples, which can provide significant RH control measures for airflow through any structure made by this newly designed PC.

In heating and cooling, air leakage through the periphery of the concrete could account for the differences observed from sample to sample. In the overall heat transfer path, heat was mainly transferred from the heating fluid to the pipe, followed by the pipe to the PC, and finally, from the PC to the air. Even if the PC and air were at the same temperature, there might be some heat loss in the pipe layers that was not taken into consideration. Heat dissipation through the exposed portion of the pipe before entering into the PC was also not accounted in this heat transfer observation. The water flow channel was in a closed-loop, and only heat was dissipated inside the concrete. Regardless of this heat loss concern, this prototype testing ensures the capability of PC in retaining normal temperature (18-28° C.) even at −20° C., and the PC can maintain a temperature above freezing point when the outdoor temperature is as low as −35° C. A similar but reverse path of heat loss appeared in cooling observation; however, the PC samples are able to maintain normal temperature even at 50° C.

Theoretically, without wishing to be bound by theory, the energy exchange in humidification should be constant as the system was isolated from its surroundings. For constant energy exchange, heat transfer decreases with greater mass transfer due to the high absorption of latent heat. In this experiment, mass transfer was not always linear with energy transfer because flowing water may not have similarly wet the PC for all PC samples, and the PC samples were not perfectly isolated from the surroundings. However, for the same inlet air temperature and humidity, all PC samples provided similar humidification data, demonstrating reproducible humidification capacity of PC. The standard deviation goes beyond 10%, because the testing procedure was changed a bit from sample to sample. The inlet air temperature and humidity conditions were not identical for all three samples. The highest temperature steps in PC sample 1 were the lowest steps of other two PC samples. Although the samples are not provided with identical humidification capacity, the trend is similar, and performance is consistent over time, and trendline offset depends on incoming air's condition.

The dehumidification capacity showed more than 10% deviation in some points because the temperature could not keep constant in comparing the sample, and the humidity sensors provided an error of ±3% for its own measurement. In spite of these errors, if the PC samples can be tested with identical and constant air condition, all samples would provide the same dehumidification/humidification capacity.

In conclusion, the heating, cooling, and RH controlling capacities of a highly porous PC were investigated in this Example. The PC demonstrated adequate heating, cooling, and RH controlling capacities, with uniform heat and mass transfer. The maximum heat transfer rate was 152.3 W during heating, and −104.3 W during cooling. Moisture transfer was considered negligible during heating and cooling. During humidification and dehumidification, the moisture transfer was 12.5 g kg⁻¹, and −5.14 g kg⁻¹, and a net energy transfer of 7.14 kJ kg⁻¹ and −17.51 kJ kg⁻¹, respectively. A considerable difference between conditioning air and cooling/heating fluid is recommended to attain an effective heating and cooling effect. Similarly, a certain RH range (dry in humidification, and >40% in dehumidification) is recommended for moisture transfer, which may be enhanced by using high energy carrying heating/cooling fluid other than water. This Example demonstrates the utility of using PC as a construction material for green roofs or green walls, and it demonstrates dual potential by conditioning the air while providing structural support.

### Example 2: Air Circulation Through Porous Concrete with a Vegetation Layer

Similarly to Example 1, CEMEX Pervia™ technology was chosen to manufacture three cylindrical PC samples with the same dimensions (11.5 cm height and 15.24 cm diameter) and properties (specific gravity of 1.77 and 25% porosity), which were hand-packed into cylindrical cardboard molds with an exact water-binder ratio of 0.2. The selected type of aggregate (Quarzsand, 2-3.2 mm) was used to build the samples with CEMEX Vertua™ binder technology. PC mixing, packing, curing, and other casting processes were conducted following the standard procedure developed by CEMEX Global Research and Development for cement-free porous plant growing substrate. Three evenly spaced (2.54 cm) plastic pipes forming Z-shaped coils as in Example 1 (FIGS. 3A and 3B) were placed in each cylindrical PC sample during casting. Two polyethylene (PE) coils, with a heat transfer rate of 14.76 W m⁻² K⁻¹ to 17.60 W m⁻² K⁻¹, were used for heating and cooling at both sides of the cast PC cylinders. These pipes were 105 cm in length, had an outer diameter equaling 0.635 cm, an inner diameter of 0.432 cm of inner diameter, and a 1-mm perimetric thickness. The first coil was termed the “back coil” and the second (outer) coil was termed the “front coil”, following the direction of airflow. The third pipe consisted of polyvinyl chloride (PVC), with a heat transfer rate of 5.68 W m⁻² K⁻¹. This pipe had an inner diameter equaling 0.31 cm, and it was placed in the middle of each PC cylinder to flow water through it. The PVC pipe (105 cm long) was uniformly perforated at 2.5-cm intervals with pinholes to disperse water inside the PC under pressure.

Ryegrass was selected to develop a vegetation layer on each PC sample. After casting, PC cylinders were soaked for one week in full-strength Hoagland solution to neutralize its alkaline effect. After soaking, one face of each cylindrical PC samples (0.018 m²) was sown with a monolayer of approximately 15.1 g grass seeds, then covered with moistened paper towels to ensuring germination over the entire surface (FIG. 14). Seeded PC cylinders were placed in a container with full-strength Hoagland solution (pH 6.1 and electrical conductivity [EC] of 1.8 mS cm⁻¹). Hoagland solution pH and EC were monitored weekly using a pH and EC meter (Lumo-X 3-in-1 meter, Lumo-X, Markham, ON, Canada). The solution was replaced bi-weekly in the first 30-day growing period, and weekly from days 30-60. Regular LED light (1000-1100 μmoles m⁻² s⁻¹) with a 16-h photoperiod was provided during the entire 60-day grass-growing period, upon reaching a uniform grass density of 3.3±1.1 pieces cm⁻² for all PC samples. Grass was cut to 15.24 cm (6 in) and a vegetated PC cylinder was inserted into the experimental setup (FIG. 14).

The experimental setup is shown in FIGS. 3A, 3B, and 14, where each vegetated PC cylinder was placed in a wind tunnel to permit airflow during testing. A hydroponic pump (PonicsPump-PP29105, PhonicsPumps, US) with a 0.01 m³ s⁻¹ capacity was used to supply the hydroponic solution to the vegetated PC. A heated water bath was used to supply hot water (up to 90° C.) at a flow rate of 23 mL s⁻¹. For cold water, an ice-bath was used to attain a water temperature of 1-2° C., with the same flow rate. Hydroponic solution at room temperature (20-22° C.) was circulated through the water pipe to control moisture content in the vegetated PC. The vegetated PC cylinder was connected to an air-flowing duct with the same diameter (15.24 cm) (FIG. 14). The air duct was connected to three centrifugal fans connected in parallel, which provided a specific airflow capacity (6.68×10⁻³ m³ s⁻¹) and an air velocity of 0.3 m s⁻¹ through the PC. The heating system, cooling system, and other accessories were connected to the experimental setup to provide a range of supply air temperatures to the vegetated PC cylinder. A domestic space heater (Stanley: 675919 C, Stanley Black & Decker Inc., Towson, Md., US) of 1500 W capacity provided hot air, and the cold outdoor air was used directly for cold airflow through the PC. Temperature, humidity, and pressure sensors (Adafruit: BME680, Adafruit Industries, New York, N.Y., US) were placed before and after the vegetated PC cylinder. A digital hot wire anemometer was used to record the flow velocity of air through the PC; it also provided an air temperature reading.

Data were collected using a Python-coded automatic data logger connected to two temperature and humidity sensors placed before and after each vegetated PC sample (FIG. 14). Temperature, pressure, and RH data were recorded at 7-s intervals during testing until conditions stabilized (1600-4000 s). During heating tests, the hot water temperature was varied from 40° C. to 90° C., at 10° C. increments. The heat transfer rate was calculated by measuring the temperature of inlet and outlet air. For cooling tests, the ice bath was held at 2° C. to circulate the water, and the incoming air temperature varied a low level (28° C., and 45% RH), medium level (31° C., and 42% RH), and high level (37° C., and 40% RH). During humidification tests, water was uniformly provided to the PC cylinder using a hydroponic pump, and the air temperature varied at the low level (25° C., and 65% RH), medium level (34° C., and 48% RH), and high level (37° C., and 38% RH). The wet PC cylinder provided outlet air with high RH, and moisture exchange was calculated by using inlet and outlet RH data with air flow rate. For dehumidification tests, humid air was created separately and passed through the PC samples. Three-level of humid air: low (23° C., and 90% RH), medium (25° C., and 87% RH), and high (27° C., and 85% RH) was supplied after enabling the cooling system during dehumidification effect testing. The dehumidification capacity of vegetated PC was also examined.

During heating tests, hot water was supplied from the heated water bath through the front coil, back coil, and both coils together. The water supply temperature was controlled by the heating bath. The air flowed through the PC was perpendicular to the water flow inside the PC. The experimental apparatus heated the cold air, and the heat exchange rate through the PC (between water and air) was calculated from the inlet and outlet temperature of the air (Equation 2.1):

Q=\dot{m}cₚΔT, (2.1)

Where Q=heat exchange inside the concrete (W), \dot{m}=mass flow rate of air inside the concrete (kg s⁻¹), and the air temperature difference was calculated (Equation 2.2) as follows:

ΔT=Tₒᵤₜ−Tᵢₙ((+ve) in heating, and (−ve) in cooling) (2.2)

where Tₒᵤₜ is the outlet air temperature (° C.), and Tᵢₙ is the inlet air temperature (° C.).

The mass transfer rate was calculated from the RH change in inlet and outlet air. The dry air of two different temperatures (low and high) was followed though the vegetated PC cylinder to measure the moisture transfer rate. The moisture transfer rate was calculated as follows (Equation 2.3):

ΔW=\dot{m}×(wₒᵤₜ−wᵢₙ) (2.3)

Where, \dot{m} is the mass flow rate of air (kg s⁻¹), and wₒᵤₜ, and wᵢₙ are the humidity ratio (g kg⁻¹) before and after the PC block. The temperature and RH were measured before and after the PC cylinder, and the humidity ratio was calculated from that temperature and RH readings with the help of the psychometric relationship (Equations 2.4, 2.5, and 2.6):

$${p}_{s} = 0.611 \times Exp ( \frac{17.27 \times T}{237 + T} ) \qquad ( 2.4 )$$

$${p}_{i} = {p}_{s} \times RH \qquad ( 2.5 )$$

$${w}_{i} = 0.62198 \times ( \frac{{p}_{i}}{p - {p}_{i}} ) \qquad ( 2.6 )$$

Where, T=air temperature (C), pᵢ=partial pressure of water vapour in air at any RH, (kPa), pₛ=partial pressure of water vapor in air at saturation, (kPa), p=atmospheric air pressure, (101.325 kPa). A large amount of latent heat was transferred with the moisture transfer on the air. Therefore, apart from the sensible heat and mass transfer, the total energy transfer was estimated by calculating the change of enthalpy in the air as described in Equation 2.7:

Δh=hₒᵤₜ−hᵢₙ (2.7)

Where, hₒᵤₜ and hᵢₙ are the total energy (enthalpy) of outgoing air and incoming air of concrete, respectively. Enthalpy amount was calculated as follows (Equation 2.8):

h=(1.006×T)+w(2501+1.805×T), (2.8)

For Equation (7), if the energy is transferred from water to air, the change of enthalpy becomes positive, and if the energy is transferred from air to water, the change in enthalpy is negative.

Statistical analyses were performed to verify reproducibility and trend similarities for each vegetated PC cylinder when determining heat and moisture transfer capacity. For heating, reproducibility of the heat transfer rate was analyzed between all three vegetated PC cylinders at each temperature increment. For cooling, reproducibility between PC samples was verified for each coil arrangement. For humidification and dehumidification, reproducibility of the mass transfer rate for all three vegetated PC cylinders was analyzed at the same inlet air temperature level (low, medium, and high). Reproducibility was verified by calculating the standard deviation between all results by using following Equations 2.9, and 2.10:

$$Mean , μ = {\sum }_{i = 1}^{N} \frac{{S}_{i}}{N} \qquad ( 2.9 )$$

$$Variance , Var = {\sum }_{i = 1}^{N} \frac{{( μ - {S}_{i} )}^{2}}{N - 1} , \\ and Standard deviation , σ = \sqrt{Var} \qquad ( 2.1 )$$

Where, Sᵢ is the ith sample's value of the measured parameter, and N is the number of samples.

Vegetated PC's potential as a building material with HVAC control was investigated by heating, cooling, humidifying, and dehumidifying air as it passed through a PC cylinder upon which ryegrass was grown.

To assess the heat transfer capacity of vegetated PC, heat generated from hot water varying from 40° C. to 90° C. was used. Temperature and changes in RH with heat transfer for 90° C. water flow is shown in FIG. 15. When water was heated to 90° C., the actual temperature change was approximately 5° C. when the input air temperature was 28° C. However, the maximum possible temperature change was 35.5° C., when calculated from total energy transfer. Change in RH was considerable, from 53% to 79%, indicating that air could still carry more moisture until saturation.

Heat, mass, and energy transfer when heating with different inlet air temperatures through vegetated PC is shown in FIG. 16. The maximum temperature change varied from 10.2±1.3° C. to 35.5±0.61° C. The temperature changing rate decreased from 40° C. to 60° C. and then increased till 90° C. Maximum heat and moisture transfer rates were 238.8±4.1 W and 12.85±0.91 g kg⁻¹, respectively, and the maximum energy transfer rate obtained was 36.82±0.95 kJ kg⁻¹. The standard deviation between samples was within 10% of maximum values.

To determine cooling capacity, tests were conducted by flowing cold water (1.5±0.5° C.) continuously through a vegetated PC cylinder and by varying the inlet air condition within low (L; 28° C. with 45% RH), medium (M; 31° C. with 42% RH), and high (H; 37° C. with 40% RH) temperature ranges. The outlet air temperature is reduced with sensible cooling until saturation, and then with condensation of moisture that causes high RH outlet with cold air. Temperature changes, RH, and heat transfer for a representative PC cylinder are shown in FIG. 17. At a low temperature, maximum temperature and RH changes were 35% and −5.21° C. At medium and high inlet air temperatures, maximum values were 41% and −10° C., and 48.5% and −19.56° C., respectively.

Outlet air temperature decreased considerably from inlet air temperature, and the heat transfer rate increased with the temperature of the inlet air. The maximum observed temperature change was −17.54±2.0° C., and heat, mass, and energy transfer were −116.65±7.99 W, −4.45±0.3 g kg⁻¹, and −29.46±2.21 kJ kg⁻¹, respectively (FIG. 18). All negative values indicate the heat, mass, and energy absorption tendency of the vegetated PC cylinders were within 15% of respective values, and high variations of results were obtained between low and medium level inlet air. The slope of the heat transfer increment was flatter from low to medium inlet air temperatures than the slope from medium to high inlet air temperatures during cooling.

To check the moisture enriching capacity of vegetated PC, humidification of the inlet air was changed and monitored under low (25° C., and 65% RH), medium (34° C., and 48% RH), and high (37° C., and 38% RH) conditions. Trends in temperature and RH changes of a representative vegetated PC sample are shown in FIG. 19. Under low conditions, temperature and RH changes were −4° C. and 24.48%, respectively, −11.09° C. with 51.73% RH under medium conditions, and 11.8° C. and 53% at high conditions. Temperature and RH changes were comparable under medium and high conditions because both conditions had similar overall enthalpy on average; however, they had, on average, a 4° C. temperature difference. All vegetated PC cylinders tested displayed similar profiles for changes in temperature and RH. Temperature reduction showed an inversely proportional relationship with its RH improvement.

Mean changes in temperature, heat, mass, and overall energy of vegetated PC are shown in FIG. 20. Under low temperature conditions, vegetated PC provided 2.56±0.48 g kg⁻¹ mass transfer, with −36.4±6.85 W heat transfer and 0.98±0.14 kJ kg⁻¹ of energy transfer. For medium conditions, mass, heat, and energy transfer were 2.36±0.58 g kg⁻¹, −80.38±2.58 W, and −6.37±0.95 kJ kg⁻¹, respectively, and for high conditions, 3.42±0.34 g kg⁻¹, −103.61±8.58 W, and −7.08±1.06 kJ kg⁻¹, respectively. Mass and energy transfer under low temperature conditions were positive, whereas, under medium and high humidification conditions, only the mass transfer showed positive, while energy transfer displayed negative values. All vegetated PC cylinders showed similar profiles from low level to high level of air, with up to 15% standard deviation.

Dehumidification tests were conducted by cooling-condensation of humid air, using three high-humidity experimental conditions: low (23° C., and 90% RH), medium (25° C., and 87% RH), and high (27° C., and 85% RH). Air was circulated through the vegetated PC to check its capacity to change air moisture content. Temperature and humidity profiles of a representative PC sample are presented in FIG. 21. Under all three conditions, the outlet air temperature decreased from the inlet air temperature because of continuous cooling. In the low temperature range, the observed temperature change was −6.8° C., with an RH change of −10.78%. Under medium temperature conditions, temperature and RH changes were −7.76° C. and −9.09%, respectively, and −8.53° C. and −8.21% RH for high temperature conditions. Dehumidification occurred by lowering the temperature, indicates a large amount of moisture removal from the air. Maximum obtained RH reductions were approximately −40.04%, −40.87%, and 41.7% under the low, medium, and low air temperature conditions, respectively.

Heat, mass, and energy transfer rates in vegetated PC are presented in FIG. 22. Under low-temperature conditions, the heat, mass, and energy transfer rates were −45.65±1.75 W, −7.4±0.72 g kg⁻¹, and −25.72±2.3 kJ kg⁻¹, respectively. Heat, mass, and energy transfer rates under medium temperature and high-temperature conditions were −51.97±2 W, −8.42±0.82 g kg⁻¹, and −29.39±2.64 kJ kg⁻¹, respectively, and −57.26±2.20 W, −9.04±0.9 g kg⁻¹, and −31.77±2.9 kJ kg⁻¹, respectively. Rates were comparable between all three vegetated PC cylinders, with standard deviations within 10%.

Vegetated PC was tested for air stabilizing properties without any energy consumption. Humid air at three different inlet air temperatures was considered: low (23° C., and 92% RH), medium (25° C., and 90% RH), and high (27° C., and 88% RH). Air was circulated through the vegetated PC to investigate passive dehumidification. Temperature and RH changes under all three conditions for a representative vegetated PC cylinder are presented in FIG. 23. Under low-temperature conditions, the temperature change was 1.1° C., and the RH change was −6.4%. Temperature and RH changes were 0.26° C., −13.81% for medium air temperature conditions, and −2.26° C. and −11.58% for high air temperature conditions.

Heat, mass, and energy transfer rates exhibited different behaviour depending on the inlet air conditions (FIG. 24). At low temperature, heat, mass, and energy transfer rates were 5.57±0.28 W, −0.7±0.04 g kg⁻¹, and −0.93±0.04 kJ kg⁻¹, respectively. Heat, mass, and energy transfer rates were −0.98±0.05 W, −3.07±0.15 g kg⁻¹, and −7.96±0.4 kJ kg⁻¹, respectively, for medium air temperature conditions, and −9.06±0.45 W, −4.57±0.22 g kg⁻¹, and −9.26±0.46 kJ kg⁻¹, respectively, for high air temperature conditions.

The main objective of this Example was to assess the heat and mass transfer of vegetated PC by assessing heating, cooling, humidification, and dehumidification capacity. Vegetated PC exhibited expected capacities for heating, cooling, and humidification. Vegetated PC showed excellent passive dehumidification when highly humid air passed through the vegetation layer. Causes for profile trends and fluctuations for all tests are discussed below.

Theoretically, during heating any object, the temperature increment of that object should be proportional to the heating source. When vegetated PC was heated, the heat transfer rate proportionally increased, but the incremental rate was slow until hot water reached 60° C., when the curve displayed a downward slope. After 60° C., the changing rate was high, and the slope displayed an upward incremental rate. This may be due to 15.24 cm grass layer growing on the PC. Indeed, the vegetated layer has a tendency to absorb heat from a heat source. Once it goes beyond the grass layer's heat retention capacity, temperature showed a sharp increment with changing hot water temperature. The same was observed for moisture and overall energy exchange. As a heat-carrying object, PC provides a steady heat transfer rate with heating source temperature. Observed data variations may be due to the added vegetation layer. The maximum possible calculated temperature change (35.5° C.) was higher than the actual temperature change (5° C.), because heating was conducted with humidification and the inlet temperature was so high (28° C.), absorbing enough moisture to reach the moisture saturation point. If the inlet temperature was low (close to 0° C.), this maximum possible temperature change could be obtained, as stated from the maximum energy transfer rate value (36.82±0.95 kJ kg⁻¹).

When cooling, temperature decreased with increasing RH in the air. This was not due to mass transfer, but the temperature reduction psychometrically increased the RH with the same moisture content in the air. Heat, mass, and energy were reduced remarkably from the inlet to outlet air. As the inlet air was not humid, the mass change was low, and very little dehumidification occurred. The heat transfer rate increment from low to medium showed a flatter slope, but from medium to high, it showed a sharp increment in rate. The slope variation may be due to the primary energy in the inlet air, and the grass layer's heat-reluctant behaviour. The highest inlet air temperature corresponded to the highest total energy transfer capacity. Additionally, sensible cooling affects much for its high temperature. Moreover, from low to medium level, the temperature change is 3° C., which did not make a large change in energy carrying capacity of vegetated PC. With a low inlet temperature (<20° C.), cooling might not work effectively because of the vegetation layer. Green vegetation always tried to keep itself at a balanced temperature; therefore, before a certain level of inlet temperature, the cooling was not significant. When cooling at a low air temperature (<20° C.), there was a high possibility of positive mass transfer if the PC was provided with dry (<30% RH) inlet air.

During humidification, the heating/cooling coils were turned off so that the latent heat of evaporation taken from the air inside the PC caused a decrease in outlet air temperature. When inlet air temperature was low (25° C.), RH increased impactfully without any heating source that lowers the air temperature, but that temperature change did not overcome the RH changing consequence on overall energy transfer. In actuality, the positive mass transfer represents water evaporation from PC to air, which reduces the outlet air temperature. When inlet air temperature was high (37° C.), apart from the latent heat of evaporation, the vegetated PC reduced the outlet temperature, as the grass layer always attempts to maintain stable temperature and humidity. When the inlet air temperature was at medium (34° C. and 48% RH) and high (37° C. and 38% RH) levels, outlet temperature reduction affected the overall energy transfer more than the RH increment, resulting in negative energy transfer. Moisture transfer is highly dependent on the moisture content of the inlet air. If two inlet streams have the same overall energy but have different moisture content, the stream with less moisture content would be more useful in humidification. A similar observation was made when comparing medium and high inlet air temperature, where the high level air had a comparatively lower moisture content with higher temperature (moisture taking capacity) and displayed a greater humidification effect than medium-level air. Ultimately, a high inlet air temperature (37° C.) could provide 1.5 times higher humidification effect than inlet air at 34° C.

Dehumidification of air circulating through vegetated PC proved challenging because the vegetated PC was always wet during tests, the grass was grown hydroponically, and the live biomass retained moisture. Highly humid air (85-90%) was circulated through the vegetated PC and the moisture removal rate was consistent under all tested conditions, increasing slightly from low to high. The noted temperature change was minimal (4° C.), and RH change was low; therefore, the moisture content in inlet air was not highly different from one sample to another. The maximum possible dehumidification rate obtained as −9.04±0.9 g kg⁻¹, and this was only obtained if dehumidification was conducted on hot and humid air. Maximum possible dehumidification is the indication of the ultimate energy absorption capacity of PC from flowing air. The incremental slope of heat, mass and energy transfer was steady throughout the experiment, and variations of between PC samples were within 7%.

Vegetated PC showed extensive passive dehumidification, even when cooling was not provided. Dehumidification was approximately 50% of actual cooling dehumidification, and it proved the natural tendency of a biomass layer to protect air from extreme conditions. In passive dehumidification, the vegetated PC showed positive temperature change with low mass transfer when the air temperature was 23° C. This is because when the moisture condensed in the vegetation layer, it released the latent heat of condensation. When the air was at room temperature, it took that heat to become warmer than inlet. The observed temperature change was minimal (1.1° C.) with minimal moisture reduction (−0.7±0.04 g kg⁻¹). With medium (25° C., and 90% RH) and high (25° C., and 88% RH) air temperature, the outlet air temperature was lower than that of the inlet air, because the inlet temperature was higher than the PC and vegetation layer. Some heat was absorbed in the vegetation layer with mass reduction. In terms of RH, a high air temperature showed 2% less RH change than medium temperature, and this was a consequence of a larger temperature change in high-temperature air. At a higher temperature range, if the temperature is reduced with moisture content, this results in a lesser RH reduction than would occur at a lower temperature range. Because with the same moisture content, low-temperature air showed higher RH value.

HVAC control with vegetated PC was attained using water as the energy-transferring medium. Heating and cooling control yielded promising data, with a maximum energy transfer of 36.82±0.95 kJ kg⁻¹. The hydroponic solution provided to the ryegrass layer affected moisture control in vegetated PC. The passive dehumidification capacity of vegetated PC proved the tendency of green biomass in neutralizing extreme inlet air conditions. All HVAC control displayed by vegetated PC was highly dependent on incoming inlet air conditions. Humidification occurs during heating if inlet air is dry, and condensation of moisture occurs during cooling when the inlet air temperature went lower than the due point. Dehumidification through vegetated PC was inadequate without humid inlet air. These processes are not independent and can not be separated from each other with these test conditions. If it is possible to control the hygroscopic properties of a hydroponic solution, all four processes could be demonstrated separately and independent of each other. However, for cooling-dehumidification and heating-humidification, vegetated PC in this type of setup could prove useful. This Example demonstrated a HVAC control technology and an application for PC for green building design, including interior and exterior green walls or rooftop hydroponic plant production systems.

As can be seen therefore, the examples described above and illustrated are intended to be exemplary only. The scope is indicated by the appended claims.

What is claimed is:

1. A system for circulating air, the system comprising:
a concrete element being an open cell porous matrix concrete and having inner surface opposite an outer surface, the inner surface facing an enclosed space of a building, and a thickness between the outer surface and the inner surface;
an air circulation conduit in fluid flow communication with the outer surface of the concrete element; and
a fan configured to circulate air along the air circulation conduit and through the open cell porous matrix, across a thickness of the concrete element, into the enclosed space.

2. The system for circulating air according to claim 1, wherein the concrete element has a porosity of from 15 to 40%.

3. The system for circulating air according to claim 1, wherein the concrete element has a thickness of from 10 to 100 cm.

4. The system for circulating air according to claim 1, wherein the concrete element has a permeability of from 2 to 6 mm s⁻¹.

5. The system for circulating air according to claim 1, wherein a pressure differential ΔP across the thickness of the concrete element is in the range of 0.1 to 100 kPa.

6. The system for circulating air according to claim 1, wherein the air circulation conduit includes an air inlet configured to draw air from the enclosed space.

7. The system for circulating air according to claim 6, further comprising a filter positioned between the fan and the air inlet.

8. The system for circulating air according to claim 6, wherein the air circulation conduit includes an external air inlet configured to draw air from an external source and a valve configured to selectively open and close the external air inlet.

9. The system for circulating air according to claim 1, further comprising a temperature control element configured to exchange heat with the concrete element.

10. The system for circulating air according to claim 9, wherein the temperature control element is embedded within the open cell porous matrix of the concrete element.

11. The system for circulating air according to claim 1, further comprising a humidity control element in fluid communication with the concrete element.

12. The system for circulating air according to claim 11, wherein the humidity control element is embedded in the open cell porous matrix concrete.

13. The system for circulating air according to claim 1, further comprising a vegetation layer on the inner surface of the concrete element.

14. A method of circulating air through a thickness of a concrete element into an enclosed space, the method comprising:
drawing air from the enclosed space into an air circulation conduit, the air circulation conduit being in fluid flow communication with the outer surface of the concrete element; and
blowing air from the air circulation conduit through the thickness of the concrete element from the outer surface into the enclosed space.

15. The method according to claim 14, further comprising:
measuring a temperature of the enclosed space;
measuring a temperature of the concrete element;
determining whether the temperature of the enclosed space is above or below a predetermined temperature range; and
modifying the temperature of the concrete element to bring the temperature of the enclosed space to within the predetermined range.

16. The method according to claim 14, further comprising:
measuring a humidity of the enclosed space;
measuring a relative humidity of the concrete element;
determining whether the humidity of the enclosed space is above or below a predetermined humidity range; and
modifying the relative humidity of the concrete element to bring the humidity of the enclosed space to within the predetermined humidity range.

17. The method according to claim 14, further comprising filtering air with a vegetation layer on an inner surface of the concrete element opposite the outer surface.

18. The method according to claim 17, wherein the vegetation layer absorbs volatile organic compounds (VOC).

19. The method according to claim 17, wherein the vegetation layer provides oxygen to the enclosed space.

20. The method according to claim 17, wherein the vegetation layer absorbs or release moisture to control the humidity of the enclosed space.
